(19) United States
(12) Patent Application Publication
(10) Pub. No.: US 2023/0196116 A1
(43) Pub. Date: Jun. 22, 2023

(54) MACHINE LEARNING FOR CLASSIFICATION OF USERS

(71) Applicant: Ancestry.com Operations Inc., Lehi, UT (US)

(72) Inventors: Alexander Liss, Morgan Hill, CA (US); Azadeh Moghtaderi, Kentfield, CA (US); Sijia Zhang, San Francisco, CA (US)

(21) Appl. No.: 18/068,703

(22) Filed: Dec. 20, 2022

Related U.S. Application Data
(60) Provisional application No. 63/292,262, filed on Dec. 21, 2021.

(51) Int. Cl. G06N 3/088

(52) U.S. Cl. CPC G06N 3/088

(57) ABSTRACT

A method or a system for classifying users into a plurality of categories. The system uses a first machine learning (ML) model to segment users into a first plurality of groups based in part on a first set of features, indicating relative research-skill levels of the respective users. The system uses a second ML model to segment users into a second plurality of groups based in part on a second set of features, indicating relative engagement levels of the respective users. The system then uses a third ML model to classify the plurality of users into a plurality of classes based in part on the research-skill levels and the engagement levels of the respective users, and selects and presents content to the user based in part on their classifications.

### CROSS-REFERENCE TO RELATED APPLICATION

The present application claims the benefit of U.S. Provisional Pat. Application No. 63/292,262 filed on Dec. 21, 2021, which is hereby incorporated by reference in its entirety.

### FIELD

The disclosed embodiments relate to systems, methods, and/or computer-program products configured for classification of users of a platform or service.

### BACKGROUND

In numerous platforms and services for users, such as online enterprises with millions of users, it is impractical, if not impossible, to survey all users in order to understand the users’ preferences and motivations. For example, users of a genealogical research service may be merely curious users, casual users, or core users. Users in each of these groups may have different preferences for their user experience and different price points. In order to expand the service in one or more such groups of users by, e.g., targeting and personalizing a user experience therefor, it is beneficial to better understand the users.

Surveys, focus groups, and other metrics are often ill-suited to providing such insights, as they are costly and can be subject to bias. Also, because of the high cost and time-intensiveness of surveys, they are necessarily infrequently conducted. Existing attempts to understand users may include a survey-based user typing tool limited to a small group of customers. Existing efforts to segment users in a customer base may use proxies such as customer tenure to determine which group a user should be classified to.

These crude and shallow attempts are inherently subjective and artificial, and often do not reflect actual user motivations or behaviors, particularly on a large, enterprise-wide scale. Further, these existing attempts generally do not capture an objective measure of skills of a user. Moreover, due to the cost and complexity of interpreting results from such approaches, they are not usable at scale and cannot be employed frequently. For example, a survey only reflects one-time, limited, subjective insights at best into user base composition.

### SUMMARY

Embodiments described herein relate to systems, methods, and/or computer-program products configured for classification of users of a platform or service. The embodiments described herein use machine learning (ML) to automatically classify users into different categories to allow a service provider to better understand their users, and, therefore, be able to provide personalized and improved services thereto. The embodiments described herein also provide technical advantages over existing approaches, such as privacy benefits, reduced complexity, improved scaling, etc.

In embodiments, one or more ML models may be used and/or concatenated to automatically determine a classification of a user of a service platform. For example, the service platform may be a genealogical research service, and the classifications may be pertinent to users of the genealogical research service. Similar principles may be applied to other contexts and services.

In some embodiments, the ML models include a first model, a second model, and a third model. The first model is trained via unsupervised methods to segment users into a first plurality of groups based on their genealogical research skills. The second model is trained via unsupervised methods to segment users into a second plurality of groups based on their product engagement levels. Outputs of the first and second models are then utilized with other data as input features for the third model. The third model is a classification model trained via supervised methods, using user survey data or other labeled data as training instances. The third model may be configured to classify users into a plurality of classifications, such as a curious or casual user classification, and a core user classification.

In yet another embodiment, a non-transitory computer-readable medium that is configured to store instructions is described. The instructions, when executed by one or more processors, cause the one or more processors to perform a process that includes steps described in the above computer-implemented methods or described in any embodiments of this disclosure.

### BRIEF DESCRIPTION OF THE DRAWINGS

FIG. 1 illustrates a diagram of a system environment of an example computing system, in accordance with some embodiments.

FIG. 2 is a block diagram of an architecture of an example computing system, in accordance with some embodiments.

FIG. 3 is a block diagram of an architecture of an example classification system, in accordance with some embodiments.

FIG. 4 is a block diagram of an architecture of another example classification system, in accordance with some embodiments.

FIG. 5 is a chart illustrating example results of an example classification system, in accordance with some embodiments.

FIG. 6A is a chart illustrating example results of an example classification system that classifies subscribers, free trial users, and churned users separately, in accordance with some embodiments.

FIG. 6B is a chart illustrating example results of an example classification system that classifies new engagement segments, such as new subscribers, new free trial users, and newly churned users separately, in accordance with some embodiments.

FIG. 7 is a flowchart of an example method for using machine learning (ML) to classify users into a plurality of classifications.

FIG. 8 is a block diagram of an example computing device, in accordance with some embodiments.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

The figures (FIGs.) and the following description relate to preferred embodiments by way of illustration only. One of skill in the art may recognize alternative embodiments of the structures and methods disclosed herein as viable alternatives that may be employed without departing from the principles of what is disclosed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Configuration Overview

Embodiments of user classification systems and methods according to the disclosed embodiments address shortcomings in the art by training and/or providing one or more machine learning (ML) models for automatically classifying users based on the users’ engagement and skill into multiple categories, such as (but not limited to) core vs. casual/curious users. The users may be users of a particular service, such as users of a genealogical research service. One or more features are identified based on user behaviors, and the ML models are trained to take the features associated with any given user as input to output a classification of the user.

In some embodiments, multiple ML models are trained. A first ML model and a second ML model are trained via unsupervised methods. The first ML model is trained to segment users into a first plurality of segmentations, indicating relative genealogical research-skill levels of users, such as high, medium, and/or low research-skill levels. The second ML model is trained to segment users into a second plurality of segmentations, indicating relative engagement levels of users, such as high, medium, and/or low engagement levels. Once the first and second ML models are trained, for any given user, the first ML model can determine a research-skill level of the user (relative to other users), and the second ML model can determine an engagement level of the user (relative to other users).

A third ML model is trained via supervised training. In some embodiments, the training data of the third ML model includes survey data or other labeled data, labeling each user as belonging to one of a plurality of groups. The third ML model is trained to take the results of the first and second ML models to classify a user into one of the plurality of groups. The system can then select and present content to the user based in part on the classification of the user.

### Example System Environment

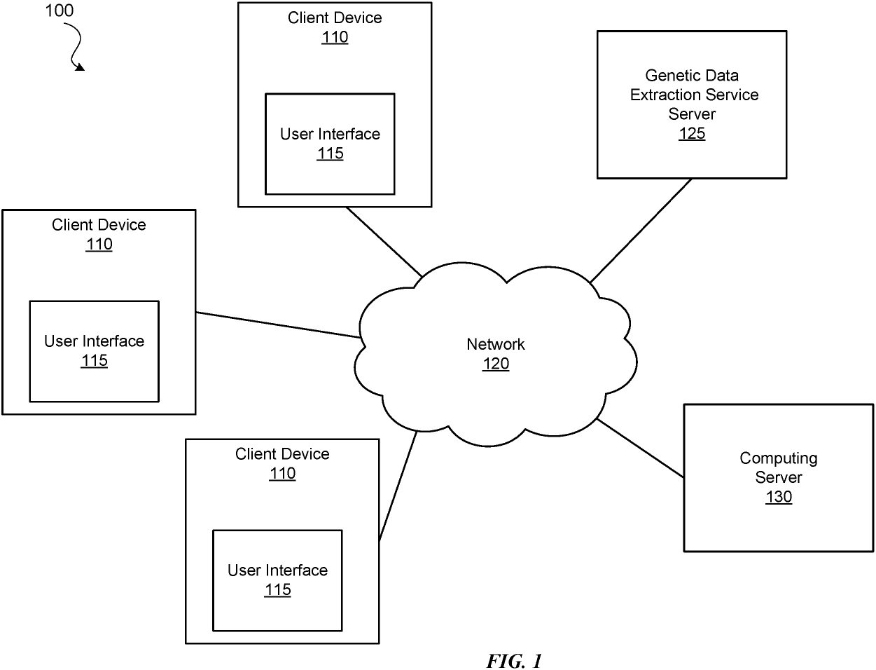

FIG. 1 illustrates a diagram of a system environment 100 of an example computing server 130, in accordance with some embodiments. The system environment 100 shown in FIG. 1 includes one or more client devices 110, a network 120, a genetic data extraction service server 125, and a computing server 130. In various embodiments, the system environment 100 may include fewer or additional components. The system environment 100 may also include different components.

The client devices 110 are one or more computing devices capable of receiving user input as well as transmitting and/or receiving data via a network 120. Example computing devices include desktop computers, laptop computers, personal digital assistants (PDAs), smartphones, tablets, wearable electronic devices (e.g., smartwatches), smart household appliances (e.g., smart televisions, smart speakers, smart home hubs), Internet of Things (IoT) devices or other suitable electronic devices. A client device 110 communicates to other components via the network 120. Users may be customers of the computing server 130 or any individuals who access the system of the computing server 130, such as an online website or a mobile application. In some embodiments, a client device 110 executes an application that launches a graphical user interface (GUI) for a user of the client device 110 to interact with the computing server 130. The GUI may be an example of a user interface 115. A client device 110 may also execute a web browser application to enable interactions between the client device 110 and the computing server 130 via the network 120. In another embodiment, the user interface 115 may take the form of a software application published by the computing server 130 and installed on the user device 110. In yet another embodiment, a client device 110 interacts with the computing server 130 through an application programming interface (API) running on a native operating system of the client device 110, such as IOS or ANDROID.

The network 120 provides connections to the components of the system environment 100 through one or more sub-networks, which may include any combination of local area and/or wide area networks, using both wired and/or wireless communication systems. In some embodiments, a network 120 uses standard communications technologies and/or protocols. For example, a network 120 may include communication links using technologies such as Ethernet, 802.11, worldwide interoperability for microwave access (WiMAX), 3G, 4G, Long Term Evolution (LTE), 5G, code division multiple access (CDMA), digital subscriber line (DSL), etc. Examples of network protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over a network 120 may be represented using any suitable format, such as hypertext markup language (HTML) or extensible markup language (XML). In some embodiments, all or some of the communication links of a network 120 may be encrypted using any suitable technique or techniques such as secure sockets layer (SSL), transport layer security (TLS), virtual private networks (VPNs), Internet Protocol security (IPsec), etc. The network 120 also includes links and packet switching networks such as the Internet.

Individuals, who may be customers of a company operating the computing server 130, provide biological samples for analysis of their genetic data. Individuals may also be referred to as users. In some embodiments, an individual uses a sample collection kit to provide a biological sample (e.g., saliva, blood, hair, tissue) from which genetic data is extracted and determined according to nucleotide processing techniques such as amplification and sequencing. Amplification may include using polymerase chain reaction (PCR) to amplify segments of nucleotide samples. Sequencing may include sequencing of deoxyribonucleic acid (DNA) sequencing, ribonucleic acid (RNA) sequencing, etc. Suitable sequencing techniques may include Sanger sequencing and massively parallel sequencings such as various next-generation sequencing (NGS) techniques including whole genome sequencing, pyrosequencing, sequencing by synthesis, sequencing by ligation, and ion semiconductor sequencing. In some embodiments, a set of SNPs (e.g., 300,000) that are shared between different array platforms (e.g., Illumina OmniExpress Platform and Illumina HumanHap 650Y Platform) may be obtained as genetic data. Genetic data extraction service server 125 receives biological samples from users of the computing server 130. The genetic data extraction service server 125 performs sequencing of the biological samples and determines the base pair sequences of the individuals. The genetic data extraction service server 125 generates the genetic data of the individuals based on the sequencing results. The genetic data may include data sequenced from DNA or RNA and may include base pairs from coding and/or noncoding regions of DNA.

The genetic data may take different forms and include information regarding various biomarkers of an individual. For example, in some embodiments, the genetic data may be the base pair sequence of an individual. The base pair sequence may include the whole genome or a part of the genome such as certain genetic loci of interest. In another embodiment, the genetic data extraction service server 125 may determine genotypes from sequencing results, for example by identifying genotype values of single nucleotide polymorphisms (SNPs) present within the DNA. The results in this example may include a sequence of genotypes corresponding to various SNP sites. An SNP site may also be referred to as an SNP loci. A genetic locus is a segment of a genetic sequence. A locus can be a single site or a longer stretch. The segment can be a single base long or multiple bases long. In some embodiments, the genetic data extraction service server 125 may perform data pre-processing of the genetic data to convert raw sequences of base pairs to sequences of genotypes at target SNP sites. Since a typical human genome may differ from a reference human genome at only several million SNP sites (as opposed to billions of base pairs in the whole genome), the genetic data extraction service server 125 may extract only the genotypes at a set of target SNP sites and transmit the extracted data to the computing server 130 as the genetic dataset of an individual. SNPs, base pair sequences, genotypes, haplotypes, RNA sequences, protein sequences, and phenotypes are examples of biomarkers.

The computing server 130 performs various analyses of the genetic data, genealogy data, and users’ survey responses to generate results regarding the phenotypes and genealogy of users of computing server 130. Depending on the embodiments, the computing server 130 may also be referred to as an online server, a personal genetic service server, a genealogy server, a family tree building server, and/or a social networking system. The computing server 130 receives genetic data from the genetic data extraction service server 125 and stores the genetic data in the data store of the computing server 130. The computing server 130 may analyze the data to generate results regarding the genetics or genealogy of users. The results regarding the genetics or genealogy of users may include the ethnicity compositions of users, paternal and maternal genetic analysis, identification or suggestion of potential family relatives, ancestor information, analyses of DNA data, potential or identified traits such as phenotypes of users (e.g., diseases, appearance traits, other genetic characteristics, and other non-genetic characteristics including social characteristics), etc. The computing server 130 may present or cause the user interface 115 to present the results to the users through a GUI displayed at the client device 110. The results may include graphical elements, textual information, data, charts, and other elements such as family trees.

In some embodiments, the computing server 130 also allows various users to create one or more genealogical profiles of the user. The genealogical profile may include a list of individuals (e.g., ancestors, relatives, friends, and other people of interest) who are added or selected by the user or suggested by the computing server 130 based on the genealogical records and/or genetic records. The user interface 115 controlled by or in communication with the computing server 130 may display the individuals in a list or as a family tree such as in the form of a pedigree chart. In some embodiments, subject to user’s privacy setting and authorization, the computing server 130 may allow information generated from the user’s genetic dataset to be linked to the user profile and to one or more of the family trees. The users may also authorize the computing server 130 to analyze their genetic dataset and allow their profiles to be discovered by other users.

### Example Computing Server Architecture

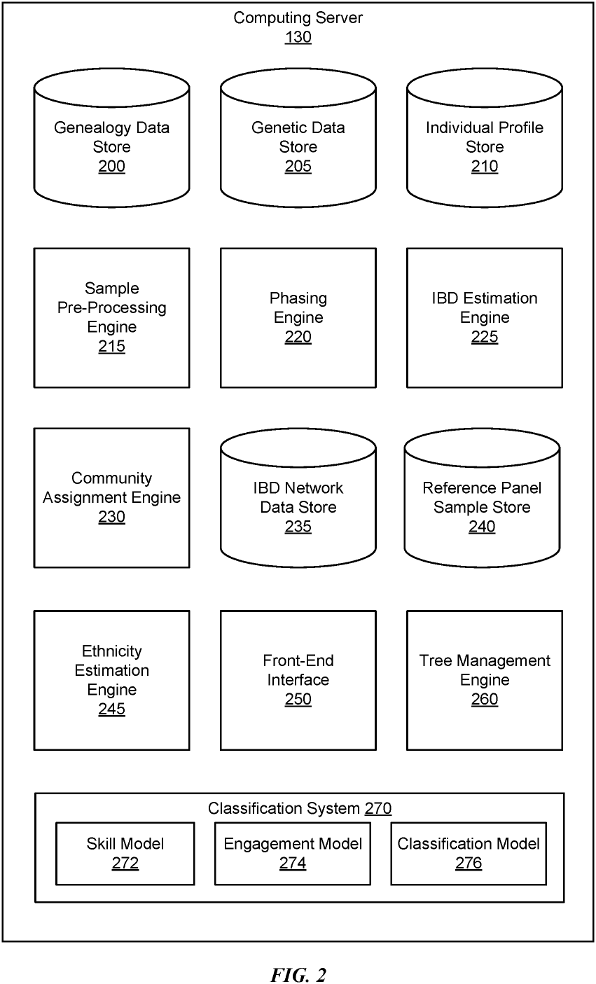

FIG. 2 is a block diagram of an architecture of an example computing server 130, in accordance with some embodiments. In the embodiment shown in FIG. 2, the computing server 130 includes a genealogy data store 200, a genetic data store 205, an individual profile store 210, a sample pre-processing engine 215, a phasing engine 220, an identity by descent (IBD) estimation engine 225, a community assignment engine 230, an IBD network data store 235, a reference panel sample store 240, an ethnicity estimation engine 245, a front-end interface 250, and a classification system 270. The functions of the computing server 130 may be distributed among the elements in a different manner than described. In various embodiments, the computing server 130 may include different components and fewer or additional components. Each of the various data stores may be a single storage device, a server controlling multiple storage devices, or a distributed network that is accessible through multiple nodes (e.g., a cloud storage system).

The computing server 130 stores various data of different individuals, including genetic data, genealogy data, and survey response data. The computing server 130 processes the genetic data of users to identify shared identity-by-descent (IBD) segments between individuals. The genealogy data and survey response data may be part of user profile data. The amount and type of user profile data stored for each user may vary based on the information of a user, which is provided by the user as she creates an account and profile at a system operated by the computing server 130 and continues to build her profile, family tree, and social network at the system and to link her profile with her genetic data. Users may provide data via the user interface 115 of a client device 110. Initially and as a user continues to build her genealogical profile, the user may be prompted to answer questions related to the basic information of the user (e.g., name, date of birth, birthplace, etc.) and later on more advanced questions that may be useful for obtaining additional genealogy data. The computing server 130 may also include survey questions regarding various traits of the users such as the users’ phenotypes, characteristics, preferences, habits, lifestyle, environment, etc.

Genealogy data may be stored in the genealogy data store 200 and may include various types of data that are related to tracing family relatives of users. Examples of genealogy data include names (first, last, middle, suffixes), gender, birth locations, date of birth, date of death, marriage information, spouse’s information kinships, family history, dates and places for life events (e.g., birth and death), other vital data, and the like. In some instances, family history can take the form of a pedigree of an individual (e.g., the recorded relationships in the family). The family tree information associated with an individual may include one or more specified nodes. Each node in the family tree represents the individual, an ancestor of the individual who might have passed down genetic material to the individual, and the individual’s other relatives including siblings, cousins, and offspring in some cases. Genealogy data may also include connections and relationships among users of the computing server 130. The information related to the connections among a user and her relatives that may be associated with a family tree may also be referred to as pedigree data or family tree data.

In addition to user-input data, genealogy data may also take other forms that are obtained from various sources such as public records and third-party data collectors. For example, genealogical records from public sources include birth records, marriage records, death records, census records, court records, probate records, adoption records, obituary records, etc. Likewise, genealogy data may include data from one or more family trees of an individual, the Ancestry World Tree system, a Social Security Death Index database, the World Family Tree system, a birth certificate database, a death certificate database, a marriage certificate database, an adoption database, a draft registration database, a veterans database, a military database, a property records database, a census database, a voter registration database, a phone database, an address database, a newspaper database, an immigration database, a family history records database, a local history records database, a business registration database, a motor vehicle database, and the like.

Furthermore, the genealogy data store 200 may also include relationship information inferred from the genetic data stored in the genetic data store 205 and information received from the individuals. For example, the relationship information may indicate which individuals are genetically related, how they are related, how many generations back they share common ancestors, lengths and locations of IBD segments shared, which genetic communities an individual is a part of, variants carried by the individual, and the like.

The computing server 130 maintains genetic datasets of individuals in the genetic data store 205. A genetic dataset of an individual may be a digital dataset of nucleotide data (e.g., SNP data) and corresponding metadata. A genetic dataset may contain data on the whole or portions of an individual’s genome. The genetic data store 205 may store a pointer to a location associated with the genealogy data store 200 associated with the individual. A genetic dataset may take different forms. In some embodiments, a genetic dataset may take the form of a base pair sequence of the sequencing result of an individual. A base pair sequence dataset may include the whole genome of the individual (e.g., obtained from a whole-genome sequencing) or some parts of the genome (e.g., genetic loci of interest).

In another embodiment, a genetic dataset may take the form of sequences of genetic markers. Examples of genetic markers may include target SNP loci (e.g., allele sites) filtered from the sequencing results. An SNP locus that is single base pair long may also be referred to as an SNP site. An SNP locus may be associated with a unique identifier. The genetic dataset may be in a form of diploid data that includes a sequencing of genotypes, such as genotypes at the target SNP loci, or the whole base pair sequence that includes genotypes at known SNP loci and other base pair sites that are not commonly associated with known SNPs. The diploid dataset may be referred to as a genotype dataset or a genotype sequence. Genotype may have different meanings in various contexts. In one context, an individual’s genotype may refer to a collection of diploid alleles of an individual. In other contexts, a genotype may be a pair of alleles present on two chromosomes for an individual at a given genetic marker such as an SNP site.

Genotype data for an SNP site may include a pair of alleles. The pair of alleles may be homozygous (e.g., A-A or G-G) or heterozygous (e.g., A-T, C-T). Instead of storing the actual nucleotides, the genetic data store 205 may store genetic data that are converted to bits. For a given SNP site, oftentimes only two nucleotide alleles (instead of all 4) are observed. As such, a 2-bit number may represent an SNP site. For example, 00 may represent homozygous first alleles, 11 may represent homozygous second alleles, and 01 or 10 may represent heterozygous alleles. A separate library may store what nucleotide corresponds to the first allele and what nucleotide corresponds to the second allele at a given SNP site.

A diploid dataset may also be phased into two sets of haploid data, one corresponding to a first parent side and another corresponding to a second parent side. The phased datasets may be referred to as haplotype datasets or haplotype sequences. Similar to genotype, haplotype may have a different meaning in various contexts. In one context, a haplotype may also refer to a collection of alleles that corresponds to a genetic segment. In other contexts, a haplotype may refer to a specific allele at an SNP site. For example, a sequence of haplotypes may refer to a sequence of alleles of an individual that are inherited from a parent.

The individual profile store 210 stores profiles and related metadata associated with various individuals appeared in the computing server 130. A computing server 130 may use unique individual identifiers to identify various users and other non-users that might appear in other data sources such as ancestors or historical persons who appear in any family tree or genealogy database. A unique individual identifier may be a hash of certain identification information of an individual, such as a user’s account name, user’s name, date of birth, location of birth, or any suitable combination of the information. The profile data related to an individual may be stored as metadata associated with an individual’s profile. For example, the unique individual identifier and the metadata may be stored as a key-value pair using the unique individual identifier as a key.

An individual’s profile data may include various kinds of information related to the individual. The metadata about the individual may include one or more pointers associating genetic datasets such as genotype and phased haplotype data of the individual that are saved in the genetic data store 205. The metadata about the individual may also be individual information related to family trees and pedigree datasets that include the individual. The profile data may further include declarative information about the user that was authorized by the user to be shared and may also include information inferred by the computing server 130. Other examples of information stored in a user profile may include biographic, demographic, and other types of descriptive information such as work experience, educational history, gender, hobbies, or preferences, location and the like. In some embodiments, the user profile data may also include one or more photos of the users and photos of relatives (e.g., ancestors) of the users that are uploaded by the users. A user may authorize the computing server 130 to analyze one or more photos to extract information, such as the user’s or relative’s appearance traits (e.g., blue eyes, curved hair, etc.), from the photos. The appearance traits and other information extracted from the photos may also be saved in the profile store. In some cases, the computing server may allow users to upload many different photos of the users, their relatives, and even friends. User profile data may also be obtained from other suitable sources, including historical records (e.g., records related to an ancestor), medical records, military records, photographs, other records indicating one or more traits, and other suitable recorded data.

For example, the computing server 130 may present various survey questions to its users from time to time. The responses to the survey questions may be stored at individual profile store 210. The survey questions may be related to various aspects of the users and the users’ families. Some survey questions may be related to users’ phenotypes, while other questions may be related to environmental factors of the users.

Survey questions may concern health or disease-related phenotypes, such as questions related to the presence or absence of genetic diseases or disorders, inheritable diseases or disorders, or other common diseases or disorders that have a family history as one of the risk factors, questions regarding any diagnosis of increased risk of any diseases or disorders, and questions concerning wellness-related issues such as a family history of obesity, family history of causes of death, etc. The diseases identified by the survey questions may be related to single-gene diseases or disorders that are caused by a single-nucleotide variant, an insertion, or a deletion. The diseases identified by the survey questions may also be multifactorial inheritance disorders that may be caused by a combination of environmental factors and genes. Examples of multifactorial inheritance disorders may include heart disease, Alzheimer’s disease, diabetes, cancer, and obesity. The computing server 130 may obtain data on a user’s disease-related phenotypes from survey questions about the health history of the user and her family and also from health records uploaded by the user.

Survey questions also may be related to other types of phenotypes such as appearance traits of the users. A survey regarding appearance traits and characteristics may include questions related to eye color, iris pattern, freckles, chin types, finger length, dimple chin, earlobe types, hair color, hair curl, skin pigmentation, susceptibility to skin burn, bitter taste, male baldness, baldness pattern, presence of unibrow, presence of wisdom teeth, height, and weight. A survey regarding other traits also may include questions related to users’ taste and smell such as the ability to taste bitterness, asparagus smell, cilantro aversion, etc. A survey regarding traits may further include questions related to users’ body conditions such as lactose tolerance, caffeine consumption, malaria resistance, norovirus resistance, muscle performance, alcohol flush, etc. Other survey questions regarding a person’s physiological or psychological traits may include vitamin traits and sensory traits such as the ability to sense an asparagus metabolite. Traits may also be collected from historical records, electronic health records and electronic medical records.

The computing server 130 also may present various survey questions related to the environmental factors of users. In this context, an environmental factor may be a factor that is not directly connected to the genetics of the users. Environmental factors may include users’ preferences, habits, and lifestyles. For example, a survey regarding users’ preferences may include questions related to things and activities that users like or dislike, such as types of music a user enjoys, dancing preference, party-going preference, certain sports that a user plays, video game preferences, etc. Other questions may be related to the users’ diet preferences such as liking or disliking a certain type of food (e.g., ice cream, egg). A survey related to habits and lifestyle may include questions regarding smoking habits, alcohol consumption and frequency, daily exercise duration, sleeping habits (e.g., morning person versus night person), sleeping cycles and problems, hobbies, and travel preferences. Additional environmental factors may include diet amount (calories, macronutrients), physical fitness abilities (e.g. stretching, flexibility, heart rate recovery), family type (adopted family or not, has siblings or not, lived with extended family during childhood), property and item ownership (has home or rents, has a smartphone or doesn’t, has a car or doesn’t).

Surveys also may be related to other environmental factors such as geographical, social-economic, or cultural factors. Geographical questions may include questions related to the birth location, family migration history, town, or city of users’ current or past residence. Social-economic questions may be related to users’ education level, income, occupations, self-identified demographic groups, etc. Questions related to culture may concern users’ native language, language spoken at home, customs, dietary practices, etc. Other questions related to users’ cultural and behavioral questions are also possible.

For any survey questions asked, the computing server 130 may also ask an individual the same or similar questions regarding the traits and environmental factors of the ancestors, family members, other relatives, or friends of the individual. For example, a user may be asked about the native language of the user and the native languages of the user’s parents and grandparents. A user may also be asked about the health history of his or her family members.

Survey questions also may be related to users’ research-skill levels and engagement levels. Survey questions related to users’ research-skill levels may include express or implied questions, asking users to assess their own research-skill levels, such as having users select one of high, medium, or low research-skill level, or asking users whether they like certain advanced research functions that the service offers, etc. Survey questions related to engagement levels may include express or implied questions, asking users to assess their own engagement levels, such as having users select one of high, medium, or low engagement level, or asking users their frequencies of using the service. In some embodiments, the survey questions may also include multiple choices, bi-polar statements, and/or a combination thereof, e.g. how much a user agrees with “Researching family history can be too tedious to be enjoyable” and/or “Researching family history is an intuitive process.”

In addition to storing the survey data in the individual profile store 210, the computing server 130 may store some responses that correspond to data related to genealogical and genetics respectively to genealogy data store 200 and genetic data store 205.

The user profile data, photos of users, survey response data, the genetic data, and the genealogy data may be subject to the privacy and authorization setting of the users to specify any data related to the users that can be accessed, stored, obtained, or otherwise used. For example, when presented with a survey question, a user may select to answer or skip the question. The computing server 130 may present users from time to time information regarding users’ selection of the extent of information and data shared. The computing server 130 also may maintain and enforce one or more privacy settings for users in connection with the access of the user profile data, photos, genetic data, and other sensitive data. For example, the user may pre-authorize the access to the data and may change the setting as wished. The privacy settings also may allow a user to specify (e.g., by opting out, by not opting in) whether the computing server 130 may receive, collect, log, or store particular data associated with the user for any purpose. A user may restrict her data at various levels. For example, on one level, the data may not be accessed by the computing server 130 for purposes other than displaying the data in the user’s own profile. On another level, the user may authorize anonymization of her data and participate in studies and researches conducted by the computing server 130 such as a large-scale genetic study. On yet another level, the user may turn some portions of her genealogy data public to allow the user to be discovered by other users (e.g., potential relatives) and be connected to one or more family trees. Access or sharing of any information or data in the computing server 130 may also be subject to one or more similar privacy policies. A user’s data and content objects in the computing server 130 may also be associated with different levels of restriction. The computing server 130 may also provide various notification features to inform and remind users of their privacy and access settings. For example, when privacy settings for a data entry allow a particular user or other entities to access the data, the data may be described as being “visible,” “public,” or other suitable labels, contrary to a “private” label.

In some cases, the computing server 130 may have a heightened privacy protection on certain types of data and data related to certain vulnerable groups. In some cases, the heightened privacy settings may strictly prohibit the use, analysis, and sharing of data related to a certain vulnerable group. In other cases, the heightened privacy settings may specify that data subject to those settings require prior approval for access, publication, or other use. In some cases, the computing server 130 may provide the heightened privacy as a default setting for certain types of data, such as genetic data or any data that the user marks as sensitive. The user may opt in to sharing of those data or change the default privacy settings. In other cases, the heightened privacy settings may apply across the board for all data of certain groups of users. For example, if computing server 130 determines that the user is a minor or has recognized that a picture of a minor is uploaded, the computing server 130 may designate all profile data associated with the minor as sensitive. In those cases, the computing server 130 may have one or more extra steps in seeking and confirming any sharing or use of the sensitive data.

The sample pre-processing engine 215 receives and pre-processes data received from various sources to change the data into a format used by the computing server 130. For genealogy data, the sample pre-processing engine 215 may receive data from an individual via the user interface 115 of the client device 110. To collect the user data (e.g., genealogical and survey data), the computing server 130 may cause an interactive user interface on the client device 110 to display interface elements in which users can provide genealogy data and survey data. Additional data may be obtained from scans of public records. The data may be manually provided or automatically extracted via, for example, optical character recognition (OCR) performed on census records, town or government records, or any other item of printed or online material. Some records may be obtained by digitalizing written records such as older census records, birth certificates, death certificates, etc.

The sample pre-processing engine 215 may also receive raw data from genetic data extraction service server 125. The genetic data extraction service server 125 may perform laboratory analysis of biological samples of users and generate sequencing results in the form of digital data. The sample pre-processing engine 215 may receive the raw genetic datasets from the genetic data extraction service server 125. The human genome mutation rate is estimated to be 1.1*10^-8 per site per generation. This may lead to a variant of approximately every 300 base pairs. Most of the mutations that are passed down to descendants are related to single-nucleotide polymorphism (SNP). SNP is a substitution of a single nucleotide that occurs at a specific position in the genome. The sample pre-processing engine 215 may convert the raw base pair sequence into a sequence of genotypes of target SNP sites. Alternatively, the pre-processing of this conversion may be performed by the genetic data extraction service server 125. The sample pre-processing engine 215 identifies autosomal SNPs in an individual’s genetic dataset. In some embodiments, the SNPs may be autosomal SNPs. In some embodiments, 700,000 SNPs may be identified in an individual’s data and may be stored in genetic data store 205. Alternatively, in some embodiments, a genetic dataset may include at least 10,000 SNP sites. In another embodiment, a genetic dataset may include at least 100,000 SNP sites. In yet another embodiment, a genetic dataset may include at least 300,000 SNP sites. In yet another embodiment, a genetic dataset may include at least 1,000,000 SNP sites. The sample pre-processing engine 215 may also convert the nucleotides into bits. The identified SNPs, in bits or in other suitable formats, may be provided to the phasing engine 220 which phases the individual’s diploid genotypes to generate a pair of haplotypes for each user.

The phasing engine 220 phases diploid genetic dataset into a pair of haploid genetic datasets and may perform an imputation of SNP values at certain sites whose alleles are missing. An individual’s haplotype may refer to a collection of alleles (e.g., a sequence of alleles) that are inherited from a parent.

Phasing may include a process of determining the assignment of alleles (particularly heterozygous alleles) to chromosomes. Owing to sequencing conditions and other constraints, a sequencing result often includes data regarding a pair of alleles at a given SNP locus of a pair of chromosomes but may not be able to distinguish which allele belongs to which specific chromosome. The phasing engine 220 uses a genotype phasing algorithm to assign one allele to a first chromosome and another allele to another chromosome. The genotype phasing algorithm may be developed based on an assumption of linkage disequilibrium (LD), which states that haplotype in the form of a sequence of alleles tends to cluster together. The phasing engine 220 is configured to generate phased sequences that are also commonly observed in many other samples. Put differently, haplotype sequences of different individuals tend to cluster together. A haplotype-cluster model may be generated to determine the probability distribution of a haplotype that includes a sequence of alleles. The haplotype-cluster model may be trained based on labeled data that includes known phased haplotypes from a trio (parents and a child). A trio is used as a training sample because the correct phasing of the child is almost certain by comparing the child’s genotypes to the parent’s genetic datasets. The haplotype-cluster model may be generated iteratively along with the phasing process with a large number of unphased genotype datasets. The haplotype-cluster model may also be used to impute one or more missing data.

By way of example, the phasing engine 220 may use a directed acyclic graph model such as a hidden Markov model (HMM) to perform the phasing of a target genotype dataset. The directed acyclic graph may include multiple levels, each level having multiple nodes representing different possibilities of haplotype clusters. An emission probability of a node, which may represent the probability of having a particular haplotype cluster given an observation of the genotypes may be determined based on the probability distribution of the haplotype-cluster model. A transition probability from one node to another may be initially assigned to a non-zero value and be adjusted as the directed acyclic graph model and the haplotype-cluster model are trained. Various paths are possible in traversing different levels of the directed acyclic graph model. The phasing engine 220 determines a statistically likely path, such as the most probable path or a probable path that is at least more likely than 95% of other possible paths, based on the transition probabilities and the emission probabilities. A suitable dynamic programming algorithm such as the Viterbi algorithm may be used to determine the path. The determined path may represent the phasing result. U.S. Pat. No. 10,679,729, entitled “Haplotype Phasing Models,” granted on Jun. 9, 2020, describes example embodiments of haplotype phasing.

The IBD estimation engine 225 estimates the amount of shared genetic segments between a pair of individuals based on phased genotype data (e.g., haplotype datasets) that are stored in the genetic data store 205. IBD segments may be segments identified in a pair of individuals that are putatively determined to be inherited from a common ancestor. The IBD estimation engine 225 retrieves a pair of haplotype datasets for each individual. The IBD estimation engine 225 may divide each haplotype dataset sequence into a plurality of windows. Each window may include a fixed number of SNP sites (e.g., about 100 SNP sites). The IBD estimation engine 225 identifies one or more seed windows in which the alleles at all SNP sites in at least one of the phased haplotypes between two individuals are identical. The IBD estimation engine 225 may expand the match from the seed windows to nearby windows until the matched windows reach the end of a chromosome or until a homozygous mismatch is found, which indicates the mismatch is not attributable to potential errors in phasing or imputation. The IBD estimation engine 225 determines the total length of matched segments, which may also be referred to as IBD segments. The length may be measured in the genetic distance in the unit of centimorgans (cM). A unit of centimorgan may be a genetic length. For example, two genomic positions that are one cM apart may have a 1% chance during each meiosis of experiencing a recombination event between the two positions. The computing server 130 may save data regarding individual pairs who share a length of IBD segments exceeding a predetermined threshold (e.g., 6 cM), in a suitable data store such as in the genealogy data store 200. U.S. Pat. No. 10,114,922, entitled “Identifying Ancestral Relationships Using a Continuous stream of Input,” granted on Oct. 30, 2018, and U.S. Pat. No. 10,720,229, entitled “Reducing Error in Predicted Genetic Relationships,” granted on Jul. 21, 2020, describe example embodiments of IBD estimation.

Typically, individuals who are closely related share a relatively large number of IBD segments, and the IBD segments tend to have longer lengths (individually or in aggregate across one or more chromosomes). In contrast, individuals who are more distantly related share relatively fewer IBD segments, and these segments tend to be shorter (individually or in aggregate across one or more chromosomes). For example, while close family members often share upwards of 71 cM of IBD (e.g., third cousins), more distantly related individuals may share less than 12 cM of IBD. The extent of relatedness in terms of IBD segments between two individuals may be referred to as IBD affinity. For example, the IBD affinity may be measured in terms of the length of IBD segments shared between two individuals.

Community assignment engine 230 assigns individuals to one or more genetic communities based on the genetic data of the individuals. A genetic community may correspond to an ethnic origin or a group of people descended from a common ancestor. The granularity of genetic community classification may vary depending on embodiments and methods used to assign communities. For example, in some embodiments, the communities may be African, Asian, European, etc. In another embodiment, the European community may be divided into Irish, German, Swedes, etc. In yet another embodiment, the Irish may be further divided into Irish in Ireland, Irish immigrated to America in 1800, Irish immigrated to America in 1900, etc. The community classification may also depend on whether a population is admixed or unadmixed. For an admixed population, the classification may further be divided based on different ethnic origins in a geographical region.

Community assignment engine 230 may assign individuals to one or more genetic communities based on their genetic datasets using ML models trained by unsupervised learning or supervised learning. In an unsupervised approach, the community assignment engine 230 may generate data representing a partially connected undirected graph. In this approach, the community assignment engine 230 represents individuals as nodes. Some nodes are connected by edges whose weights are based on IBD affinity between two individuals represented by the nodes. For example, if the total length of two individuals’ shared IBD segments does not exceed a predetermined threshold, the nodes are not connected. The edges connecting two nodes are associated with weights that are measured based on the IBD affinities. The undirected graph may be referred to as an IBD network. The community assignment engine 230 uses clustering techniques such as modularity measurement (e.g., the Louvain method) to classify nodes into different clusters in the IBD network. Each cluster may represent a community. The community assignment engine 230 may also determine sub-clusters, which represent sub-communities. The computing server 130 saves the data representing the IBD network and clusters in the IBD network data store 235. U.S. Pat. No. 10,223,498, entitled “Discovering Population Structure from Patterns of Identity-By-Descent,” granted on Mar. 5, 2019, describes example embodiments of community detection and assignment.

The community assignment engine 230 may also assign communities using supervised techniques. For example, genetic datasets of known genetic communities (e.g., individuals with confirmed ethnic origins) may be used as training sets that have labels of the genetic communities. Supervised ML classifiers, such as logistic regressions, support vector machines, random forest classifiers, and neural networks may be trained using the training set with labels. A trained classifier may distinguish binary or multiple classes. For example, a binary classifier may be trained for each community of interest to determine whether a target individual’s genetic dataset belongs or does not belong to the community of interest. A multi-class classifier such as a neural network may also be trained to determine whether the target individual’s genetic dataset most likely belongs to one of several possible genetic communities.

Reference panel sample store 240 stores reference panel samples for different genetic communities. A reference panel sample is a genetic data of an individual whose genetic data is the most representative of a genetic community. The genetic data of individuals with the typical alleles of a genetic community may serve as reference panel samples. For example, some alleles of genes may be over-represented (e.g., being highly common) in a genetic community. Some genetic datasets include alleles that are commonly present among members of the community. Reference panel samples may be used to train various ML models in classifying whether a target genetic dataset belongs to a community, determining the ethnic composition of an individual, and determining the accuracy of any genetic data analysis, such as by computing a posterior probability of a classification result from a classifier.

A reference panel sample may be identified in different ways. In some embodiments, an unsupervised approach in community detection may apply the clustering algorithm recursively for each identified cluster until the sub-clusters contain a number of nodes that are smaller than a threshold (e.g., contains fewer than 1000 nodes). For example, the community assignment engine 230 may construct a full IBD network that includes a set of individuals represented by nodes and generate communities using clustering techniques. The community assignment engine 230 may randomly sample a subset of nodes to generate a sampled IBD network. The community assignment engine 230 may recursively apply clustering techniques to generate communities in the sampled IBD network. The sampling and clustering may be repeated for different randomly generated sampled IBD networks for various runs. Nodes that are consistently assigned to the same genetic community when sampled in various runs may be classified as a reference panel sample. The community assignment engine 230 may measure the consistency in terms of a predetermined threshold. For example, if a node is classified to the same community 95% (or another suitable threshold) of the times whenever the node is sampled, the genetic dataset corresponding to the individual represented by the node may be regarded as a reference panel sample. Additionally, or alternatively, the community assignment engine 230 may select N most consistently assigned nodes as a reference panel for the community.

Other ways to generate reference panel samples are also possible. For example, the computing server 130 may collect a set of samples and gradually filter and refine the samples until high-quality reference panel samples are selected. For example, a candidate reference panel sample may be selected from an individual whose recent ancestors are born at a certain birthplace. The computing server 130 may also draw sequence data from the Human Genome Diversity Project (HGDP). Various candidates may be manually screened based on their family trees, relatives’ birth location, and other quality control. Principal component analysis may be used to create clusters of genetic data of the candidates. Each cluster may represent an ethnicity. The predictions of the ethnicity of those candidates may be compared to the ethnicity information provided by the candidates to perform further screening.

The ethnicity estimation engine 245 estimates the ethnicity composition of a genetic dataset of a target individual. The genetic datasets used by the ethnicity estimation engine 245 may be genotype datasets or haplotype datasets. For example, the ethnicity estimation engine 245 estimates the ancestral origins (e.g., ethnicity) based on the individual’s genotypes or haplotypes at the SNP sites. To take a simple example of three ancestral populations corresponding to African, European and Native American, an admixed user may have nonzero estimated ethnicity proportions for all three ancestral populations, with an estimate such as [0.05, 0.65, 0.30], indicating that the user’s genome is 5% attributable to African ancestry, 65% attributable to European ancestry and 30% attributable to Native American ancestry. The ethnicity estimation engine 245 generates the ethnic composition estimate and stores the estimated ethnicities in a data store of computing server 130 with a pointer in association with a particular user.

In some embodiments, the ethnicity estimation engine 245 divides a target genetic dataset into a plurality of windows (e.g., about 1000 windows). Each window includes a small number of SNPs (e.g., 300 SNPs). The ethnicity estimation engine 245 may use a directed acyclic graph model to determine the ethnic composition of the target genetic dataset. The directed acyclic graph may represent a trellis of an inter-window hidden Markov model (HMM). The graph includes a sequence of a plurality of node groups. Each node group, representing a window, includes a plurality of nodes. The nodes represent different possibilities of labels of genetic communities (e.g., ethnicities) for the window. A node may be labeled with one or more ethnic labels. For example, a level includes a first node with a first label representing the likelihood that the window of SNP sites belongs to a first ethnicity and a second node with a second label representing the likelihood that the window of SNPs belongs to a second ethnicity. Each level includes multiple nodes so that there are many possible paths to traverse the directed acyclic graph.

The nodes and edges in the directed acyclic graph may be associated with different emission probabilities and transition probabilities. An emission probability associated with a node represents the likelihood that the window belongs to the ethnicity labeling the node given the observation of SNPs in the window. The ethnicity estimation engine 245 determines the emission probabilities by comparing SNPs in the window corresponding to the target genetic dataset to corresponding SNPs in the windows in various reference panel samples of different genetic communities stored in the reference panel sample store 240. The transition probability between two nodes represents the likelihood of transition from one node to another across two levels. The ethnicity estimation engine 245 determines a statistically likely path, such as the most probable path or a probable path that is at least more likely than 95% of other possible paths, based on the transition probabilities and the emission probabilities. A suitable dynamic programming algorithm such as the Viterbi algorithm or the forward-backward algorithm may be used to determine the path. After the path is determined, the ethnicity estimation engine 245 determines the ethnic composition of the target genetic dataset by determining the label compositions of the nodes that are included in the determined path. U.S. Pat. No. 10,558,930, entitled “Local Genetic Ethnicity Determination System,” granted on Feb. 11, 2020, describes example embodiments of ethnicity estimation.

The front-end interface 250 displays various results determined by the computing server 130. The results and data may include the IBD affinity between a user and another individual, the community assignment of the user, the ethnicity estimation of the user, phenotype prediction and evaluation, genealogy data search, family tree and pedigree, relative profile and other information. The front-end interface 250 may allow users to manage their profile and data trees (e.g., family trees). The users may view various public family trees stored in the computing server 130 and search for individuals and their genealogy data via the front-end interface 250. The computing server 130 may suggest or allow the user to manually review and select potentially related individuals (e.g., relatives, ancestors, close family members) to add to the user’s data tree. The front-end interface 250 may be a graphical user interface (GUI) that displays various information and graphical elements. The front-end interface 250 may take different forms. In one case, the front-end interface 250 may be a software application that can be displayed on an electronic device such as a computer or a smartphone. The software application may be developed by the entity controlling the computing server 130 and be downloaded and installed on the client device 110. In another case, the front-end interface 250 may take the form of a webpage interface of the computing server 130 that allows users to access their family tree and genetic analysis results through web browsers. In yet another case, the front-end interface 250 may provide an application program interface (API).

The tree management engine 260 performs computations and other processes related to users’ management of their data trees such as family trees. The tree management engine 260 may allow a user to build a data tree from scratch or to link the user to existing data trees. In some embodiments, the tree management engine 260 may suggest a connection between a target individual and a family tree that exists in the family tree database by identifying potential family trees for the target individual and identifying one or more most probable positions in a potential family tree. A user (target individual) may wish to identify family trees to which he or she may potentially belong. Linking a user to a family tree or building a family may be performed automatically, manually, or using techniques with a combination of both. In an embodiment of an automatic tree matching, the tree management engine 260 may receive a genetic dataset from the target individual as input and search related individuals that are IBD-related to the target individual. The tree management engine 260 may identify common ancestors. Each common ancestor may be common to the target individual and one of the related individuals. The tree management engine 260 may in turn output potential family trees to which the target individual may belong by retrieving family trees that include a common ancestor and an individual who is IBD-related to the target individual. The tree management engine 260 may further identify one or more probable positions in one of the potential family trees based on information associated with matched genetic data between the target individual and DNA test takers in the potential family trees through one or more ML models or other heuristic algorithms. For example, the tree management engine 260 may try putting the target individual in various possible locations in the family tree and determine the highest probability position(s) based on the genetic datasets of the target individual and other DNA test takers in the family tree and based on genealogy data available to the tree management engine 260. The tree management engine 260 may provide one or more family trees from which the target individual may select. For a suggested family tree, the tree management engine 260 may also provide information on how the target individual is related to other individuals in the tree. In a manual tree building, a user may browse through public family trees and public individual entries in the genealogy data store 200 and individual profile store 210 to look for potential relatives that can be added to the user’s family tree. The tree management engine 260 may automatically search, rank, and suggest individuals for the user conduct manual reviews as the user makes progress in the front-end interface 250 in building the family tree.

As used herein, “pedigree” and “family tree” may be interchangeable and may refer to a family tree chart or pedigree chart that shows, diagrammatically, family information, such as family history information, including parentage, offspring, spouses, siblings, or otherwise for any suitable number of generations and/or people, and/or data pertaining to persons represented in the chart. U.S. Pat. No. 11,429,615, entitled “Linking Individual Datasets to a Database,” granted on Aug. 30, 2022, describes example embodiments of how an individual may be linked to existing family trees.

The classification system 270 includes one or more ML models trained to classify users into a plurality of categories. As illustrated, the classification model includes a skill model 272 (also referred to as a first ML model), an engagement model 274 (also referred to as a second ML model), and a classification model 276 (also referred to as a third ML model). In some embodiments, the skill model 272 and the engagement model 274 are trained via unsupervised methods.

The skill model 272 is trained to segment users into a first plurality of segmentations, indicating relative genealogical research-skill levels of users, such as high, medium, and/or low research-skill levels. “Skill,” as used herein, may refer to what and how a user utilizes resources on the genealogical research service, including the user’s goals and how well they are realized, and the quality of outcome of the user’s efforts on the genealogical research service. The engagement model 274 is trained to segment users into a second plurality of segmentations, indicating relative engagement levels of users, such as high, medium, and/or low engagement levels. “Engagement,” as used herein, may refer to a volume, frequency, and/or intensity of engagement by the user with the genealogical research service within a specific time frame, such as a number of searches, number of hints accepted, number of user-generated content uploads, average time per DNA visit in past 18 months, etc. Once the skill model 272 and engagement model 274 are trained, for any given user, the skill model 272 can determine a research-skill level of the user (relative to other users), and the engagement model 274 can determine an engagement level of the user (relative to other users).

In some embodiments, the classification model 276 is trained via supervised training. In some embodiments, the training data of the third ML model includes survey data or other labeled data, labeling each user as belonging to one of a plurality of groups. The classification model 276 is trained to take the results of the skill model 272 and engagement model 274 to classify a user into one of the plurality of groups. The system can then select and present content to the user based in part on the classification of the user.

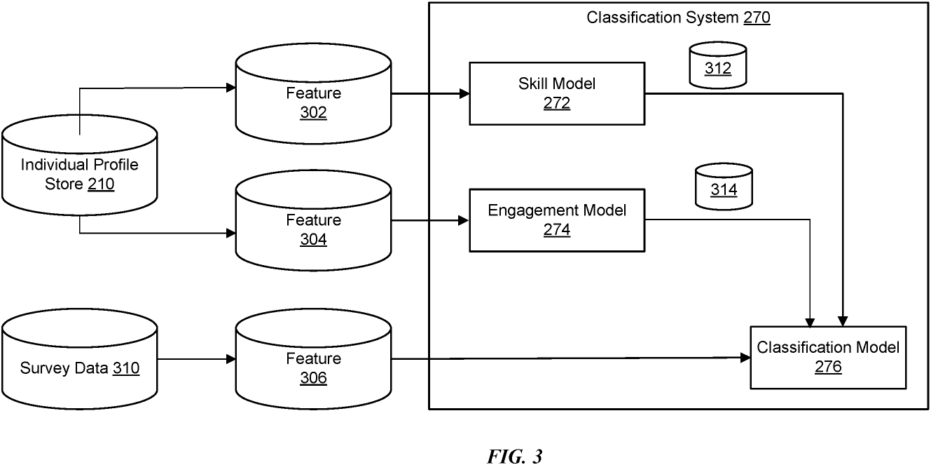

Additional details about the classification system 270 are further described below with respect to FIG. 3.

### Example Embodiment of Classification System

FIG. 3 is a block diagram of an example architecture of the classification system 270, in accordance with one or more embodiments. In some embodiments, the skill model 272 and the engagement model 274 are trained via unsupervised methods. In some embodiments, training data of the skill model 272 and engagement model 274 are obtained from data associated with user behavior or interaction with the service, which may be stored in the individual profile store 210. The skill model 272 is trained to determine a genealogical research skill of a user, such as high, medium, or low research-skill level. The engagement model 274 is trained to determine an engagement level of a user, such as high, medium, or low engagement level.

In some embodiments, the classification model 276 is trained via supervised training methods. In some embodiments, the training data of the third ML model includes survey data 310 or other labeled data, labeling each user as belonging to one of a plurality of groups. The classification model 276 is trained to take the results of the skill model 272 and the engagement model 274 to classify a user into one of the plurality of groups.

In some embodiments, the skill model 272 is configured to take a first set of features 302 associated with a user’s behavior as input, and determine a user’s research-skill level 312 as high, medium, or low based in part on the first set of features 302. The engagement model 274 is configured to take a second set of features 304 associated with the user’s behavior as input, and determine the user’s engagement level 314 as high, medium, or low based in part on the second set of features 304. The classification model 276 is configured to take the results 312 of the skill model 272 and the results 314 of the engagement model 274 as input, and determine the user as a core user, a curious and/or a casual user based in part on the results 312 and 314 of the skill model 272 and the engagement model 274.

“Core,” as used herein, may refer to users who have some awareness of the research service, find researching thereon intuitive and enjoyable, prioritize research thereon over other hobbies, is looking for unknown facts to expand their tree or other data, and/or are focused on discovering facts and connections. “Casual,” as used herein, may refer to users who start researching with little existing skill or knowledge, are interested in learning more about/from the research service but struggle with the existing experience, may see research using the service as time-consuming and/or expensive, and/or are open-minded to further discovery. “Curious,” as used herein, may refer to users who are DNA-only, would like to learn from discoveries but not drive the research thereon as they feel such research is tedious, are price- and time-sensitive, and/or who may dabble in or intend to use the research service in the future. In some embodiments, the classification model 276 also takes a third set of features 306 in addition to the results 312, 314 of the skill model 272 and engagement model 274. Note, the first, second, third sets of features 302, 304, 306 may or may not overlap with each other.

In some embodiments, the first set of features 302 are generally related to “what and how” about a user’s interaction with the service, such as the outcome of a user’s effort. Such features may include global search to wildcard search ratio, fractions of citations from hints, manual sources, creation of match groups, node completeness, etc. In particular, the first set of features 302 may include (but are not limited to) genealogical tree features, hint-related features, content-related features, DNA-related features, search-related features, device-related features, self-reported experience, and/or willingness to help other users.

For example, genealogical tree features include (but are not limited to) citation count and diversity, manual sources in trees, node completeness, comments nodes, and research tags. The hint-related features include (but are not limited to) reliance on hints, different hint page visits, and usage of tree hints and new person hints. The content-related features include (but are not limited to) browse rates of various collections, record correction rate, usage of card catalog page, and story and document user-generated content upload. DNA-related features include (but are not limited to) a number of DNA kits managed, a rate of filtering, sorting, and grouping matches, and notes added. Search-related features include (but are not limited to) types and scopes of searches, query fields and refinement, and wildcard searches.

Table 1 below lists an example set of features that may be used as the first set of features 302 for training the skill model 272. Once the skill model 272 is trained, the first set of features 302 associated with a given user is also used by the skill model 272 to determine the given user’s skill level. In embodiments, different models and/or features may be used based on geography. For example, a particular model and feature combination may correspond to users in the United States while a different combination of model and feature corresponds to users in the UK.

TABLE 1

| | | | | | |
|---|---|---|---|---|---|
| Genealogical Tree Features | Content Features | DNA Features | Search Features | Hint Features | Other Features |
| % of GEDCOM-based trees | Number of record corrections | Number of DNA kits managed | Categorical feature from tree node search, form search, both, neither | Ratio between all hint page visits and total hint page visits | Number of times using desktop version of service |
| Average node completeness score | Number of document and story user-generated content added | Number of times intended to add/edit match notes | Number of unique query parameter combinations used | Ratio between number of content merging to tree from hint and total number of merges to tree | Willing to help or not |
| Average number of citations per node | Number of collections browsed | Number of match groups created | Ratio between global searches and all searches | Whether user has turned off tree hints | Experience listed on profile |
| Diversity of record types | Number of clicks/searches on card catalog page | Number of times sorting matches | Ratio of search refinements over original search averaged over all queries | Acceptance rate of tree hint and new person hint | |
| Number of notes and comments added to tree | | Number of times filtering matches | Number of times using wildcard in searches | | |
| % of manual citations | | | | | |
| Number of citations from affiliated services | | | | | |
| Number of | | | | | |
| custom or research tags in tree | | | | | |

In some embodiments, the second set of features 304 may include (but are not limited to) volume, frequency, and intensity within a specific time frame. For example, frequency-related features may include (but not limited to) a number of user logins, a number of searches, a number of hints accepted, a number of user-generated content (UGC) uploads, average time per DNA visit in the past 18 months, etc. Intensity-related features may include (but not limited to) a number of searches, a number of hints accepted, a number of user-generated content (UGC) uploads, average time per DNA visit in each user login session. Volume-related features may include (but not limited to) various user activities since the user account is established.

Table 2 below illustrates lists an example set of features that may be used as the second set of features 304 for training the engagement model 274. Once the engagement model 274 is trained, the second set of features 304 associated with a given user is also used by the engagement model 274 to determine the given user’s engagement levels.

TABLE 2

| | | | | | |
|---|---|---|---|---|---|
| Genealogical Tree Features | Content Features | DNA Features | Search Features | Hint Features | Other Features |
| Number of trees created | Number of user-generated content uploads | Number of active days within 7 days after DNA result ready date | Number of searches | Number of hints accepted | Number of person-to-person messages sent |
| Number of nodes created | Number of content views | Number of active days within 14 days after DNA result ready date | | Number of types of hint accepted (record, object, tree, new person) | Number of posts on message board(s) |
| Number of times sharing trees with others | Number of visits | Whether link tree to DNA test | | Number of hints rejected | Number of emails opened or clicked |
| | Average time per visit | Number of shares of DNA results/account | | Number of types of hint rejected | Number of times contacting member |
| | | | | (record, object, tree, new person) | service |
| | | Number of match views | | Number of hints “maybe” | |
| | | Number of DNA story views | | | |
| | | Whether viewed community | | | |
| | | Number of DNA visits | | | |
| | | Average time per DNA visit | | | |

Above Tables 1-2 merely show some examples of features that may be used for training or taken as input by the skill model 272 and/or the engagement model 274. Other features, such as similar or equivalent features, or modifications of these features, may also be used.

As discussed above, in some embodiments, the classification model 276 is further trained over a third set of features 306 in addition to the results of the skill model 272 and engagement model 274. In some embodiments, the third set of features 306 further includes features extracted from survey data 310, such as (but not limited to) skill-stratified segments of users, engagement segments of users, curious vs. casual vs. core users, etc. The third set of features 306 may include (but is not limited to) skill levels, engagement patterns, hint behavior, search behavior, discovery behavior, genealogical tree behavior, content behavior, DNA behavior, collaboration/sharing behavior, subscription data, and others. In some embodiments, the third set of features 306 may also include features in either or both the first and/or second sets of features. In some embodiments, the third set of features 306 may include hundreds of features or more than 150 features. The features may be drawn from a plurality of feature categories, for example from more than 10 feature categories.

In some embodiments, the classification model 276 may be trained via a random guess based on overall label distribution, a tree-based ensemble model incorporating XGBoost, and/or a nearest neighbor model with typing tool probabilities as labels, for example, a soft label KNN model. In some embodiments, manual labels (also known as ground truth labels) may be provided for training the classification model 276. In some embodiments, the ground-truth labels may be extracted from survey data. Alternatively, or in addition, in some embodiments, the ground-truth labels may be generated using a typing tool. Predetermined thresholds for the sizes or proportions of the core user bucket and casual/curious user bucket may be determined and/or adjusted based on the ground-truth labels.

In some embodiments, the thresholds may be specific to current subscribers, current free trial users, and/or churned users (hereinafter also referred to as “churners”). In some embodiments, churners may include users who have been subscribers in the past, but have later unsubscribed from the service, e.g., become free trial users, or unsubscribed and stopped using the service over a period of time. If a churner resubscribes to the service, the churner would become a subscriber, i.e., no longer a churner. Alternatively, or in addition, churners may include users who have been free trial users in the past, but have stopped using the service over a period of time.

In some embodiments, the thresholds may be same for different types of users. It has been found that the proportion of core users who are current subscribers is higher than the proportion of curious/casual users. Experiments show that the classification model 276 can achieve an accuracy of upwards of 0.78 for core users and 0.65 for casual/curious users.

In some embodiments, the features are extracted from historical user data associated with user behavior or interaction with the service. Such user data may be part of a user profile stored in a user database. The users may include current subscribers, current free trial users, and churners, whose data may be processed altogether, or separately. In some embodiments, additional features may also be extracted from new data (which may include data obtained from or pertaining to new subscribers, new free trial users, and new churners from a predetermined time period, e.g., the past 18 months), daily segment generation, and outputting scores and other insights.

In some embodiments, a single set of ML models are trained and used to classify all the users, including subscribers, free trial users, and churners. In some embodiments, a separate set of ML models are trained for current subscribers, free trial users, or churners.

In some embodiments, timelines of the user data may also be considered. For example, the user data may include (but is not limited to) current status, past six months, time since DNA result ready and/or lifetime. Some count features may be normalized by time, and/or may be calculated as ratio features, which facilitates a clear separation between core and casual/curious users, although casual and curious users have fewer differences from each other.

In some embodiments, the user data and/or features may be preprocessed before input into the ML models. In some embodiments, principal component analysis (PCA) is used to reduce the dimensionality of features, e.g., the first set of features 302, the second set of features 304, and/or the third set of features 306.

In some embodiments, the skill model 272 or the engagement model 274 may use K-means clustering method to cluster or segment users into the plurality of segmentations. In some embodiments, a score is determined for each user based on their corresponding features. In some embodiments, multiple scores are determined for each user. Each of the multiple scores is associated with a particular feature or a particular subset of features. The multiple scores may then be aggregated into a single score, such as computing an average score, or weighted average score. Users are then segmented into the plurality of categories based on the score(s).

It has been surprisingly found that users of a genealogical research service, for instance, can be segmented based on skill levels using a stratification such as high skill, medium, skill, or low skill. It has been found that high-skill users tend to use diverse sources and tools, handle information more effectively, and grow genealogical trees in quality. The skill levels of users may also be measured based on a service utilization pattern, the outcome of the user’s service utilization, and other measures such as global search ratio, manual sources, match groups created, node completeness, etc. Further, the skill levels of users in genealogical research services have been found to correlate to business metrics, including life time revenue (LTR) and churn rate. For example, a higher skill corresponds to a higher LTR and lower churn rate.

It is proven that the first model described herein is capable of defining and extracting the first set of features 302 that more objectively reflect relative user skills compared to all users in a group. Users tend to overestimate their relative skill levels in a group. In particular, low-skill users tend to think of themselves as medium-skill because they are unaware of what they do not know and have outsize confidence in what they have already been able to accomplish. On the other hand, approximately half of high-skill users wrongly think of themselves as medium-skill, because they tend to compare themselves to professional or full-time genealogists. The first model described herein is trained to automatically segment users into different skill level groups based on features that advantageously overcome the problem of users misconceiving their own skill levels.

The features may be subject to various pre-processing, such as cohort-based normalization, and principal component analysis (PCA). These pre-processings further advantageously reduce information loss, provide a balanced view of different feature(s) groups, and provide flexibility for creating feature category-specific segments. For example, engagement-specific features and/or skill-specific features may be transformed by reducing dimensionality, (e.g., using PCA) and then be categorized, e.g., using k-means clustering.

Such benefits may be realized by grouping features into discrete groups and performing PCA and k-means clustering separately for each group of features as opposed to performing PCA and k-means clustering on the entire feature set. Scores for groups of features may be assigned a score, such as 0, 1, 2, 3, 4, etc. That is, a user may receive a score for tree-based engagement features of 2, a score for DNA-based engagement features of 4, a score for hint-based engagement features of 3, and so on, with these scores averaged or otherwise transformed into a final “engagement score” which can be used by a pertinent model or component to categorize the user into a cohort or class of users based on engagement, with a separate, parallel process performed for the user’s skill-based features in a corresponding model or component so as to categorize the user simultaneously or separately into a cohort or class of users based on skill. Thus, these scores for each group may be averaged across a cohort and/or category such as skills vs. engagement, to determine low, medium, high-skill users, and/or low, medium, and high-engagement users.

Segments may be determined based on one or both of the skill and engagement scores, with predetermined thresholds determined and/or assigned therefor as there has been found to be a higher LTR for groups with higher skills (though not necessarily for groups with higher engagement) and a correspondingly lower churn rate. It would be beneficial to identify lower-skill cohorts that can be educated or otherwise engaged in increasing their skills and thereby increasing LTR therefrom.

In some embodiments, a single observation window, such as 18 months, is implemented for extracting features. Alternatively, segmentation methods according to the second model may, utilize six-month windows with an exponential weighted moving average, with a higher weight for more recent activities. Alternatively, segmentation may be performed by a tenure band, e.g., < six months, six months to one year, and > one year, with different features weighted differently for different tenure bands. In some embodiments, a higher weight may be given also to features that differentiate churners vs. non-churners. Different cutoff scores may likewise be used for low, medium, and high segments.

For example, as shown in Table 3 below, different thresholds may be utilized for subscribers and free trial users across different tenure bands. In Table 3, there are two dotted lines. Users above the first or upper dotted line are deemed as high-engagement users, users below the second or lower dotted line are deemed as low-engagement users, and the users between the first and second dotted lines are deemed as medium-engagement users. For example, as shown in Table 3, a first high-engagement threshold score for subscribers within six months tenure band is 0.87, a second high-engagement threshold score for subscribers in a tenure band between six months and one year is 0.83, and a third high-engagement threshold score for subscribers in a tenure band of greater than one year is 0.88. As such, a subscriber within six months of tenure needs to have an engagement score 0.87 or higher to be deemed as a high-engagement user, a subscriber with a tenure of between six months to one year needs to have an engagement score 0.83 or higher to be deemed as a high-engagement user, and a subscriber with a tenure of greater than one year needs to have an engagement score 0.88 or higher to be deemed as a high-engagement user. Similar to the high-engagement threshold scores, different low-engagement threshold scores may be utilized for subscribers across different tenure bands. For example, as shown in Table 3, a first low-engagement threshold score for subscribers within six months tenure band is 0.04, a second low-engagement threshold score for subscribers in a tenure band between six months and one year is 0.07, and a third low-engagement threshold score for subscribers in a tenure band of greater than one year is 0.02. As such, a subscriber within a tenure of within six months needs to have an engagement score 0.04 or lower to be deemed as a low-engagement user, a subscriber with a tenure of between six months and one year needs to have an engagement score 0.07 or lower to be deemed as a low-engagement user, and a subscriber with a tenure of greater than one year needs to have an engagement score 0.02 or lower to be deemed as a low-engagement user.

TABLE 3

| Free Trial User + Subscribers: < Six Months | | Subscribers: Six Months - One Year | | Subscribers: > One Year | |
|---|---|---|---|---|---|
| User | Engagement Score | User | Engagement Score | User | Engagement Score |
| 1 | 0.98 | 1 | 0.91 | 1 | 0.93 |
| 2 | 0.87 | 2 | 0.83 | 2 | 0.88 |
| ... | ... | ... | ... | ... | ... |
| N | 0.04 | N | 0.007 | N | 0.002 |
| N+1 | 0.02 | N+1 | 0.006 | N+1 | 0.001 |

Similar to the different thresholds for segmenting different types of users into different engagement level groups described above with respect to Table 3, different threshold scores may be implemented for segmenting different types of users into different skill-level groups. By segmenting users by skill and engagement, rather than engagement alone using the principles described herein, it has been found that skill level correlates with churn rate for users with a tenure of less than six months, although higher engagement for these users is not necessarily better. On the other hand, for users with a tenure of between six and twelve months, engagement correlates with churn more than skill; and for users with a tenure beyond twelve months, higher skill and engagement levels both correlate with a lower churn rate.

In embodiments, users may be segmented based on a combination of skill score and engagement score, with seven different segments, comprising low skill + low engagement users (approximately 28% of users), low skill + medium-high engagement users (approximately 13% of users), medium skill + low engagement users (approximately 12%), medium skill + medium engagement users (approximately 34%), medium skill + high engagement users (approximately 9%), high skill + low-medium engagement users (approximately 1%), and high skill + high engagement users (approximately 3%).

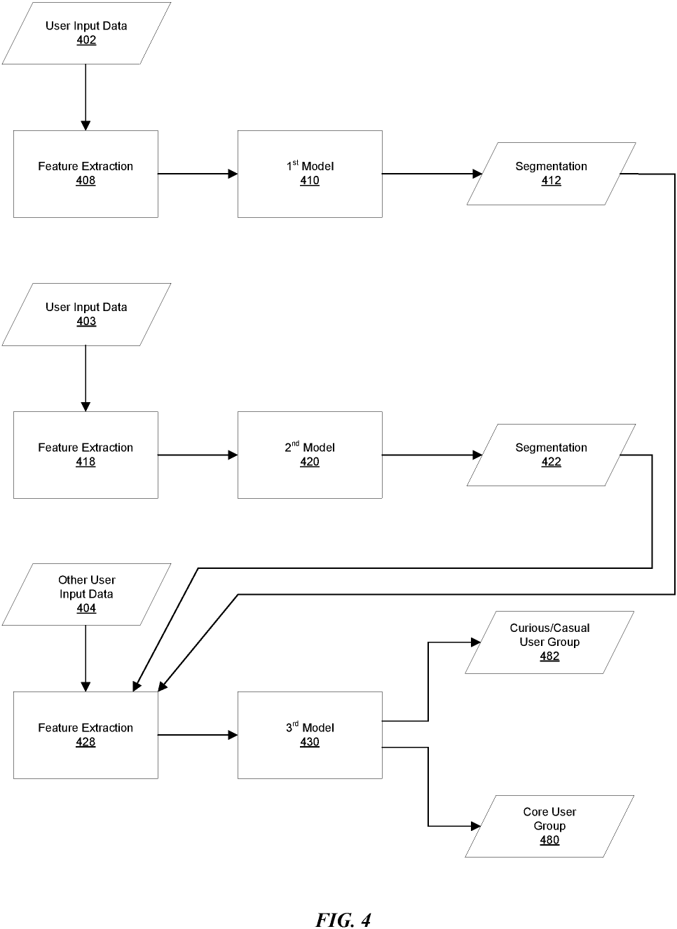

FIG. 4 is a block diagram of another example architecture of the classification system 270 of FIGS. 2-3. The classification system 270 includes first, second, and third constituent models 410, 420, 430. The first model 410 is configured to receive user input data 402 from or upon which feature extraction is performed 408, and to output a segmentation prediction 412 regarding segmentations of users based on a skill level of a user, such as low skill, medium skill, or high skill. The second model 420 is configured to receive user input data 403 from or upon which feature extraction is performed 418, and to output a segmentation prediction 422 regarding a user segmentation based on engagement level, such as low engagement, medium engagement, or high engagement. The third model 430 is configured to receive other input data 404 and the predictions or segmentations 412, 422, from or upon one or more of which feature extraction is performed 428, and is configured to classify users as being either in the core user group 480 or the curious/casual user group 482.

This may advantageously facilitate classification between core users vs. curious and casual users (who have been found to be less different from each other than they are from core users), which facilitates important behavior-based interventions with users to improve LTR and other metrics while maximizing model performance and economy of computing and training resources. However, while a binary classification of users into the groups 480, 482 is described, it will be appreciated that a classification of users into three groups respectively corresponding to core, curious, and casual is also contemplated. The disclosure is by no means limited to two- or three-class classifications, but rather other classifications may be performed as suitable.

The classification system 270 is advantageously automated, less expensive than existing approaches at classifying users, and readily scalable for daily site-wide execution. The results obtained from the classification system 270 are more accurate than the existing approaches which rely on the use of proxies for user classification. Classifying users properly allows for tailored approaches to the users, which can prevent user churn, and prolong user tenure. In some embodiments, the first and second models 410, 420 are trained using unsupervised methods, while the third model 430 is trained using supervised methods. In some embodiments, the first and second models 410, 420 may be trained using supervised methods, and/or the third model 430 may be trained using unsupervised methods. Alternatively, or in addition, the first, second, and/or third models 410, 420, 430 may be trained using a combination of supervised or unsupervised methods.

The first model 410 is configured to provide a segmentation of users based on determined skill level. This advantageously allows an enterprise to realize higher LTR, as high-skill users have been found to have nearly double the LTR of low-skill users and approximately 50% higher LTR compared to medium-skill users. Similarly, high-skill users churn at approximately 60% the rate of medium-skill users and less than 50% the rate of low-skill users. Accordingly, being able to detect high-skill users among potentially millions of users on demand is highly advantageous. It has been found that targeting educational campaigns increases skill, and accordingly, bill-through rate (“BTR”). In particular, as users increase their skill levels from low to medium, of which 10% of low skill users have been found to do, the BTR reaches 60%, higher than unchanged low-skill or medium-skill users. Additionally, the total duration of subscription to a service has been found to be proportional to skill level.

Feature extraction at step or module 408 may be configured to extract features from user data, such as data received or retrieved from a suitable source, including tree-related, hint-related, content-related, DNA-related, search-related, or other features. Unsupervised learning may be utilized to cluster users based on the extracted features. For instance, dimensionality reduction may be performed on the original data using PCA or other suitable methods to yield a lower-dimensional embedding. Additionally, alternatively, or subsequently, K-means clustering or other suitable approaches may be utilized to generate a single score for categories of features.

An average of the score for each category may be determined, or any other suitable metric, operation, or otherwise. The score may be used to predict or determine a classification or segmentation of users as high skill, medium skill, or low skill. Data for developing or training the first model 410 may include data from current subscribers and free trial users, but may be applied to current subscribers and free trial users as well as churners. In some embodiments, separate models may be trained and used for different geographic markets or locations, such as the US vs. the UK. In some embodiments, separate models may also be trained and used for different types of users, such as subscribers, free trial users, and churners.

Similarly, the second model 420 is configured to receive features extracted at 418 from user data 403, such as user data specific to skills and engagement, and generate a score and/or segmentation 422 therefrom. The extracted features that are inputted to the model 420 may include features spanning tree, hint, content, DNA, search, and/or other categories of features, within each of which a discretization of skill-related and engagement-related features may be provided or determined.

The features received by the first model 410 and/or second model 420 may first be discretized into engagement features and skill features of each category. Dimensionality of the features may be performed using any suitable modality, such as PCA, and clustering may be performed using a suitable modality, such as K-means clustering. This advantageously reduces information loss, provides a balanced view of different feature groups, and ensures flexibility of creating feature category- or group-specific segments.

Such benefits may be realized by grouping features into discrete groups and performing PCA and k-means clustering separately for each group of features as opposed to performing PCA and k-means clustering on the entire feature set. Scores for groups of features, e.g. groups of features corresponding respectively to trees, DNA, hints, search, content, etc., may be assigned a score, such as 0, 1, 2, 3, 4, etc., which may be averaged across a cohort and/or category, such as skills vs. engagement, to determine low, medium, high-skill users and/or low, medium, high-engagement users.

The third model 430 is configured to receive segmentation predictions 412, 422 from the first and second models 410, 420, respectively, as well as other user data 404, extract features at step or module 428, and then output a classification to either a core user group 482 or a curious/casual user group 480. In some embodiments, the third model may use a random guess based on overall label distribution, achieving an accuracy for core users of 0.65 and for casual/curious users of 0.35, a tree-based ensemble model with XGBoost, achieving an accuracy for core users of 0.78 and for casual/curious users of 0.65, a nearest neighbor model with typing tool probabilities as labels such as soft label KNN, achieving an accuracy for core users of 0.79 and for casual/curious users of 0.67, or any other suitable model. 150+ features may be extracted and relied upon in embodiments, drawn from categories such as skill, engagement pattern, hint, search, discovery, tree, content, DNA, collaboration, subscription, and others.

Manual labels assigning users to one of core researchers, core connectors, casual investigators, casual adventurers, and curious dabblers may be provided along with training data. The manual or ground-truth labels may be generated using a typing tool. In embodiments, the ground-truth labels are determined by the typing tool using normalized user survey response data for bi-polar statements, e.g. how much a user agrees with “Researching family history can be too tedious to be enjoyable” vs. “Researching family history is an intuitive process.” An optimal threshold for a percentage of users in core versus casual/curious may be determined based on survey data, user research, and/or domain knowledge. Core users may be 40% of users. In other embodiments, core users may be 25% of users.

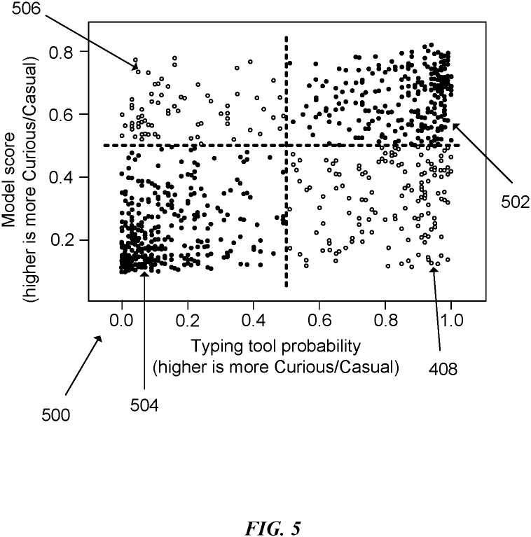

FIG. 5 is a graph 500 illustrating results of the categorization performed by the categorization system 270 described herein. The graph 500 demonstrates the correct classification of casual/curious users 502 vs. the correct classification of core users 504, with a comparatively sparse distribution of incorrectly classified users 506, 508.

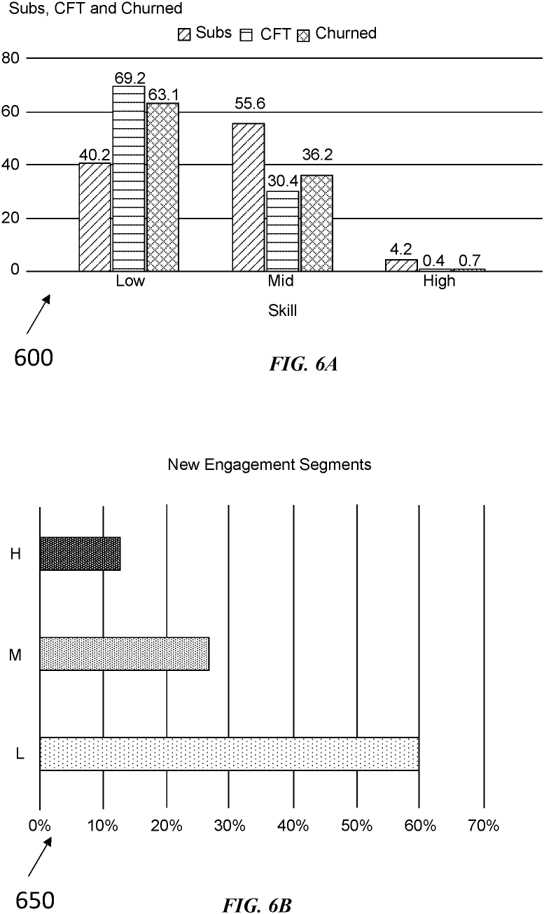

FIG. 6A is a bar chart 600 illustrating results of the classification system 270 applied to existing subscribers, free trial users, and churned users. FIG. 6B is a bar chart 650 illustrating results of the classification system 270 applied to new subscribers, new free trial users, and newly churned users. As seen in FIGS. 6A and 6B, the first and second models 410, 420 advantageously are configured to segment users into skill strata (low, medium, high) based on subscribers, current free trial users (“CFT”), and churned users (FIG. 6A) and into engagement strata (low, medium, high) (FIG. 6B). An exponentially weighted moving average may be used to assign higher weights for more-recent activities. This allows for considering recency by considering effects and trends within the last six months and other time frames.

### Example Method for Using Ml Models to Classify Users

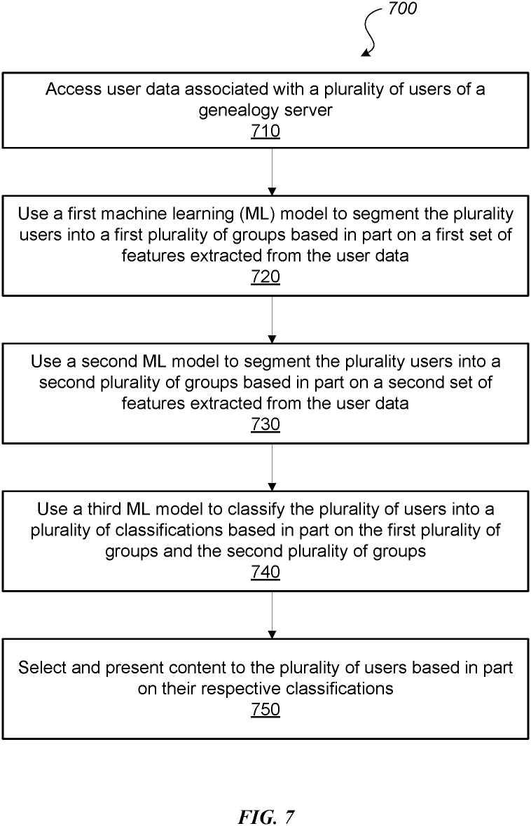

FIG. 7 is a flowchart of one embodiment of a process 700 for using ML to classify users. In various embodiments, the method includes different or additional steps than those described in conjunction with FIG. 7. Further, in some embodiments, the steps of the method may be performed in different orders than the order described in conjunction with FIG. 7. The method described in conjunction with FIG. 7 may be carried out by the computing server 130 in various embodiments, while in other embodiments, the steps of the method are performed by any online system capable of accessing databases and running ML models.

In some embodiments, process 700 can include accessing user data associated with a plurality of users of a service, such as a genealogy service (step 710). In some embodiments, the user data may be stored in the individual profile store 210 of the computing server 130. The user data includes data associated with user interactions with the computing server 130, such as search functions used, hints accepted, family tree created or accessed, user-generated content uploaded, etc.

Continuing with reference to FIG. 7, in some embodiments, process 700 can include using a first ML model to segment the plurality of users into a first plurality of groups based in part on a first set of features extracted from the user data (step 720). The first set of features is associated with the plurality of users’ historical usage of a plurality of research functions provided by the computing server. The first plurality of groups indicates relative research-skill levels of the respective plurality of users. In some embodiments, the first ML model is trained using an unsupervised learning method, such as k-means clustering method. For example, the plurality of users may be segmented into three groups, namely, high skill, medium skill, and low skill, indicating the users’ relative research-skill levels. The users in the high research skill group have relatively high research-skill levels compared to the rest of the users; the users in the low research skill group have relatively low research-skill levels compared to the rest of the users; and so on and so forth.

In some embodiments, process 700 can include using a second ML model to segment the plurality of users into a second plurality of groups based in part on a second set of features extracted from the user data (step 730). The second set of features is associated with volumes, frequencies, or intensity of the plurality of users interacting with the computing server. In some embodiments, the second ML model is trained using an unsupervised learning method, such as k-means clustering method. The second plurality of groups indicates relative engagement levels of the respective plurality of users. For example, similar to the skill levels, the plurality of users may be segmented into three groups, namely, high engagement, medium engagement, and low engagement, indicating the users’ relative engagement levels. The users in the high engagement level group have relative high engagement levels compared to the rest of the users; the users in the low engagement level group have relative low engagement levels compared to the rest of the users; and so on and so forth.

In some embodiments, the first set of features and/or the second set of features include features associated with activities of the plurality of users during a particular time frame. In some embodiments, a first subset of features is associated with activities of the plurality of users during a first time frame, and a second subset of features is associated with activities of the plurality of users during second time frame. The first subset of features and the second subset of features are assigned different weights. In some embodiments, when the first time frame is more recent than the second time frame, the first subset of features is given a greater weight than the second subset of features.

In some embodiments, for each of the plurality of users, the first or second ML model computes a score for the user based on the first set of features or the second set of features, selects a set of cut-off scores, and segments the plurality of users into the first or second plurality of groups based in part on the set of cut-off scores. In some embodiments, the plurality of users includes a first subset of users who are current subscribers of the genealogy service, a second subset of users who are current free-trial users of the genealogy service, and a third subset of users who are churners. The first or second ML model selects different sets of cut-off scores for the first, second, or third subsets of users.

In some embodiments, an average or any other suitable transformation of the determined scores from each category for skill or engagement may be determined. In some embodiments, the strata for skill or engagement may be dependent on user tenure. That is, tenure-bands may be determined for, e.g., zero - six-month users, six-month to 12-month users, and 12-month-plus users, with different weighting and cutoff thresholds applied in embodiments to one or more of the tenure bands. In some embodiments, an exponential weighted moving average, with a higher weight for more-recent activities, is applied to one or more of the tenure bands. For example, features can be weighted differently using information value, with higher weight for features that differentiate churners vs. non-churners.

In some embodiments, the process 700 can include using a third ML model to classify the plurality of users into a plurality of classifications based in part on the first plurality of groups and the second plurality of groups of the plurality of users (step 740). In some embodiments, the third ML model further takes a third set of features associated with the plurality of users in addition to the first plurality of groups and the second plurality of groups resulting from the first and second ML models. In some embodiments, the third set of features are extracted from survey data or other labeled instances associated with the plurality of users, in which each of the plurality of users is labeled as one of the plurality of classes. In some embodiments, the third ML model is trained using a supervised learning method.

In some embodiments, the process 700 can include selecting and presenting content to the plurality of users based in part on their respective classifications (step 750). In some embodiments, the plurality of classifications may include a core-user classification and a casual- or curious-user classification. Based on the research results, the classifications correlate with other metrics, such as business metrics, e.g., users’ LTR, and churn rate. Knowing a user’s classification allows the genealogy service to tailor the service to the user. For example, a core user may be more interested in advanced research features, and the genealogy service may provide suggestions to the core user related to additional advanced research features, or present advanced research features more prominently on the user interface. As another example, a casual or curious user may not know how to user advanced research features, but is open to results generated automatically. The genealogy service may execute a search query, e.g. for a predicted ancestor of the user, automatically based on the causal or curious user’s information and present the query result to the causal or curious user. Alternatively, certain casual or curious users may be open to learning new skills, and tutorials for advance research features may be suggested to these casual or curious users, turning the casual or curious users into core users.

### Example Ml Models

In various embodiments, a wide variety of ML techniques may be used. Examples include different forms of supervised learning, unsupervised learning, and semi-supervised learning such as decision trees, support vector machines (SVMs), regression, Bayesian networks, and genetic algorithms. Deep learning techniques such as neural networks, including convolutional neural networks (CNN), recurrent neural networks (RNN) and long short-term memory networks (LSTM), may also be used. For example, various object recognitions performed by visual reference engine, localization, recognition of objects and particularly thin objects, and other processes may apply one or more ML and deep learning techniques.

In various embodiments, the training techniques for an ML model may be supervised, semi-supervised, or unsupervised. In supervised learning, the ML models may be trained with a set of training samples that are labeled. For example, for an ML model trained to classify objects, the training samples may be different pictures of objects labeled with the type of objects. The labels for each training sample may be binary or multi-class. In training an ML model for image segmentation, the training samples may be pictures of regularly shaped objects in various storage sites with segments of the images manually identified. In some cases, an unsupervised learning technique may be used. The samples used in training are not labeled. Various unsupervised learning technique such as clustering may be used. In some cases, the training may be semi-supervised with training set having a mix of labeled samples and unlabeled samples.

An ML model may be associated with an objective function, which generates a metric value that describes the objective goal of the training process. For example, the training may intend to reduce the error rate of the model in generating predictions. In such a case, the objective function may monitor the error rate of the ML model. In object recognition (e.g., object detection and classification), the objective function of the ML algorithm may be the training error rate in classifying objects in a training set. Such an objective function may be called a loss function. Other forms of objective functions may also be used, particularly for unsupervised learning models whose error rates are not easily determined due to the lack of labels. In image segmentation, the objective function may correspond to the difference between the model’s predicted segments and the manually identified segments in the training sets. In various embodiments, the error rate may be measured as cross-entropy loss, L1 loss (e.g., the sum of absolute differences between the predicted values and the actual value), L2 loss (e.g., the sum of squared distances).

An ML model may include certain layers, nodes, kernels and/or coefficients. Training of a neural network may include forward propagation and backpropagation. Each layer in a neural network may include one or more nodes, which may be fully or partially connected to other nodes in adjacent layers. In forward propagation, the neural network performs the computation in the forward direction based on outputs of a preceding layer. The operation of a node may be defined by one or more functions. The functions that define the operation of a node may include various computation operations such as convolution of data with one or more kernels, pooling, recurrent loop in RNN, various gates in LSTM, etc. The functions may also include an activation function that adjusts the weight of the output of the node. Nodes in different layers may be associated with different functions.

Each of the functions in the neural network may be associated with different coefficients (e.g. weights and kernel coefficients) that are adjustable during training. In addition, some of the nodes in a neural network may also be associated with an activation function that decides the weight of the output of the node in forward propagation. Common activation functions may include step functions, linear functions, sigmoid functions, hyperbolic tangent functions (tanh), and rectified linear unit functions (ReLU). After an input is provided into the neural network and passes through a neural network in the forward direction, the results may be compared to the training labels or other values in the training set to determine the neural network’s performance. The process of prediction may be repeated for other images in the training sets to compute the value of the objective function in a particular training round. In turn, the neural network performs backpropagation by using gradient descent such as stochastic gradient descent (SGD) to adjust the coefficients in various functions to improve the value of the objective function.

Multiple rounds of forward propagation and backpropagation may be performed. Training may be completed when the objective function has become sufficiently stable (e.g., the ML model has converged) or after a predetermined number of rounds for a particular set of training samples. The trained ML model can be used for performing prediction, object detection, image segmentation, or another suitable task for which the model is trained.

### Computing Machine Architecture

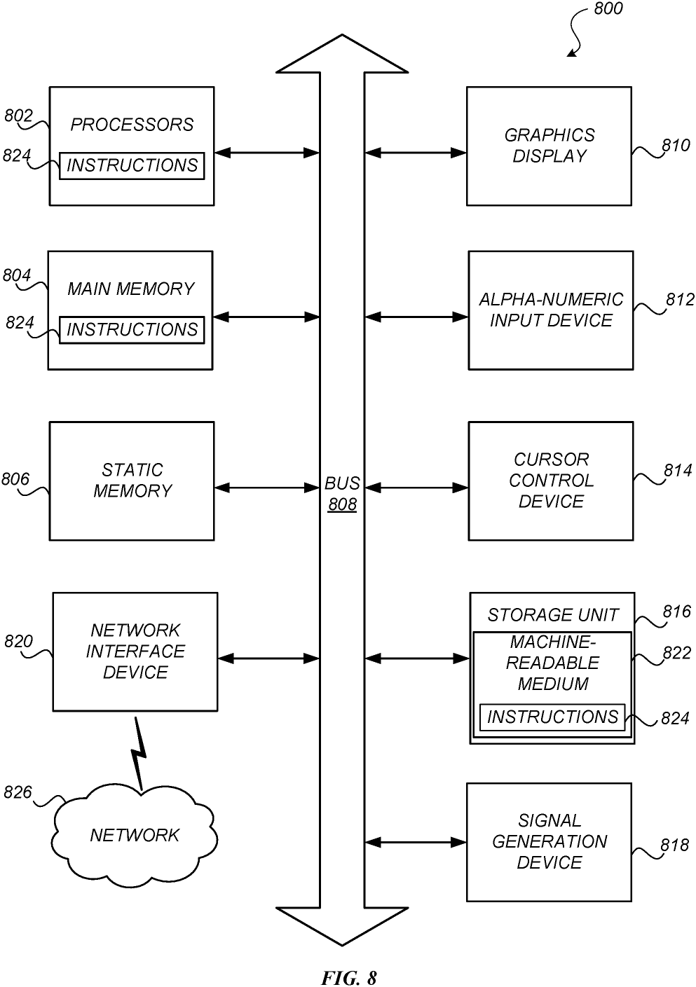

FIG. 8 is a block diagram illustrating components of an example computing machine that is capable of reading instructions from a computer-readable medium and execute them in a processor (or controller). A computer described herein may include a single computing machine shown in FIG. 8, a virtual machine, a distributed computing system that includes multiple nodes of computing machines shown in FIG. 8, or any other suitable arrangement of computing devices.

By way of example, FIG. 8 shows a diagrammatic representation of a computing machine in the example form of a computer system 800 within which instructions 824 (e.g., software, source code, program code, expanded code, object code, assembly code, or machine code), which may be stored in a computer-readable medium for causing the machine to perform any one or more of the processes discussed herein may be executed. In some embodiments, the computing machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

The structure of a computing machine described in FIG. 8 may correspond to any software, hardware, or combined components shown in FIGS. 1-4, including but not limited to, the client device 110, the computing server 130, and various engines, interfaces, terminals, and machines shown in FIG. 2. While FIG. 8 shows various hardware and software elements, each of the components described in FIGS. 1-4 may include additional or fewer elements.

By way of example, a computing machine may be a personal computer (PC), a tablet PC, a set-top box (STB), a personal digital assistant (PDA), a cellular telephone, a smartphone, a web appliance, a network router, an internet of things (IoT) device, a switch or bridge, or any machine capable of executing instructions 824 that specify actions to be taken by that machine. Further, while only a single machine is illustrated, the term “machine” and “computer” may also be taken to include any collection of machines that individually or jointly execute instructions 824 to perform any one or more of the methodologies discussed herein.

The example computer system 800 includes one or more processors 802 such as a CPU (central processing unit), a GPU (graphics processing unit), a TPU (tensor processing unit), a DSP (digital signal processor), a system on a chip (SOC), a controller, a state equipment, an application-specific integrated circuit (ASIC), a field-programmable gate array (FPGA), or any combination of these. Parts of the computing system 800 may also include a memory 804 that store computer code including instructions 824 that may cause the processors 802 to perform certain actions when the instructions are executed, directly or indirectly by the processors 802. Instructions can be any directions, commands, or orders that may be stored in different forms, such as equipment-readable instructions, programming instructions including source code, and other communication signals and orders. Instructions may be used in a general sense and are not limited to machine-readable codes. One or more steps in various processes described may be performed by passing through instructions to one or more multiply-accumulate (MAC) units of the processors.

One and more methods described herein improve the operation speed of the processors 802 and reduces the space required for the memory 804. For example, the database processing techniques and ML methods described herein improve accuracy of user classification and allow scalability. Once the models are built, for any given user, the user may be classified in near real time as long as there is sufficient user data. The models are small in size, and can be executed as a cloud service, or be deployed onto a mobile application of a client device.

The performance of certain operations may be distributed among more than one processor, not only residing within a single machine, but deployed across a number of machines. In some example embodiments, the one or more processors or processor-implemented modules may be located in a single geographic location (e.g., within a home environment, an office environment, or a server farm). In other example embodiments, one or more processors or processor-implemented modules may be distributed across a number of geographic locations. Even though in the specification or the claims may refer some processes to be performed by a processor, this should be construed to include a joint operation of multiple distributed processors.

The computer system 800 may include a main memory 804, and a static memory 806, which are configured to communicate with each other via a bus 808. The computer system 800 may further include a graphics display unit 810 (e.g., a plasma display panel (PDP), a liquid crystal display (LCD), a projector, or a cathode ray tube (CRT)). The graphics display unit 810, controlled by the processors 802, displays a graphical user interface (GUI) to display one or more results and data generated by the processes described herein. The computer system 800 may also include alphanumeric input device 812 (e.g., a keyboard), a cursor control device 814 (e.g., a mouse, a trackball, a joystick, a motion sensor, or other pointing instruments), a storage unit 816 (a hard drive, a solid-state drive, a hybrid drive, a memory disk, etc.), a signal generation device 818 (e.g., a speaker), and a network interface device 820, which also are configured to communicate via the bus 808.

The storage unit 816 includes a computer-readable medium 822 on which is stored instructions 824 embodying any one or more of the methodologies or functions described herein. The instructions 824 may also reside, completely or at least partially, within the main memory 804 or within the processor 802 (e.g., within a processor’s cache memory) during execution thereof by the computer system 800, the main memory 804 and the processor 802 also constituting computer-readable media. The instructions 824 may be transmitted or received over a network 826 via the network interface device 820.

While computer-readable medium 822 is shown in an example embodiment to be a single medium, the term “computer-readable medium” should be taken to include a single medium or multiple media (e.g., a centralized or distributed database, or associated caches and servers) able to store instructions (e.g., instructions 824). The computer-readable medium may include any medium that is capable of storing instructions (e.g., instructions 824) for execution by the processors (e.g., processors 802) and that cause the processors to perform any one or more of the methodologies disclosed herein. The computer-readable medium may include, but not be limited to, data repositories in the form of solid-state memories, optical media, and magnetic media. The computer-readable medium does not include a transitory medium such as a propagating signal or a carrier wave.

### Additional Considerations

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Any feature mentioned in one claim category, e.g. method, can be claimed in another claim category, e.g. computer program product, system, storage medium, as well. The dependencies or references back in the attached claims are chosen for formal reasons only. However, any subject matter resulting from a deliberate reference back to any previous claims (in particular multiple dependencies) can be claimed as well, so that any combination of claims and the features thereof is disclosed and can be claimed regardless of the dependencies chosen in the attached claims. The subject matter may include not only the combinations of features as set out in the disclosed embodiments but also any other combination of features from different embodiments. Various features mentioned in the different embodiments can be combined with explicit mentioning of such combination or arrangement in an example embodiment or without any explicit mentioning. Furthermore, any of the embodiments and features described or depicted herein may be claimed in a separate claim and/or in any combination with any embodiment or feature described or depicted herein or with any of the features.

Some portions of this description describe the embodiments in terms of algorithms and symbolic representations of operations on information. These operations and algorithmic descriptions, while described functionally, computationally, or logically, are understood to be implemented by computer programs or equivalent electrical circuits, microcode, or the like. Furthermore, it has also proven convenient at times to refer to these arrangements of operations as engines, without loss of generality. The described operations and their associated engines may be embodied in software, firmware, hardware, or any combinations thereof.

Any of the steps, operations, or processes described herein may be performed or implemented with one or more hardware or software engines, alone or in combination with other devices. In some embodiments, a software engine is implemented with a computer program product comprising a computer-readable medium containing computer program code, which can be executed by a computer processor for performing any or all of the steps, operations, or processes described. The term “steps” does not mandate or imply a particular order. For example, while this disclosure may describe a process that includes multiple steps sequentially with arrows present in a flowchart, the steps in the process do not need to be performed in the specific order claimed or described in the disclosure. Some steps may be performed before others even though the other steps are claimed or described first in this disclosure. Likewise, any use of (i), (ii), (iii), etc., or (a), (b), (c), etc. in the specification or in the claims, unless specified, is used to better enumerate items or steps and also does not mandate a particular order.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein. In addition, the term “each” used in the specification and claims does not imply that every or all elements in a group need to fit the description associated with the term “each.” For example, “each member is associated with element A” does not imply that all members are associated with an element A. Instead, the term “each” only implies that a member (of some of the members), in a singular form, is associated with an element A. In claims, the use of a singular form of a noun may imply at least one element even though a plural form is not used.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights.

The following applications are incorporated by reference in their entirety for all purposes: (1) U.S. Pat. No. 10,679,729, entitled “Haplotype Phasing Models,” granted on Jun. 9, 2020, (2) U.S. Pat. No. 10,223,498, entitled “Discovering Population Structure from Patterns of Identity-By-Descent,” granted on Mar. 5, 2019, (3) U.S. Pat. No. 10,720,229, entitled “Reducing Error in Predicted Genetic Relationships,” granted on Jul. 21, 2020, (4) U.S. Pat. No. 10,558,930, entitled “Local Genetic Ethnicity Determination System,” granted on Feb. 11, 2020, (5) U.S. Pat. No. 10,114,922, entitled “Identifying Ancestral Relationships Using a Continuous Stream of Input,” granted on Oct. 30, 2018, and (6) U.S. Pat. No. 11,429,615, entitled “Linking Individual Datasets to a Database,” granted on Aug. 30, 2022.

What is claimed is:

1. A computer-implemented method, comprising:
accessing user data associated with a plurality of users of a genealogy service, user data comprising data associated with user interactions with the genealogy service;
using a first machine learning (ML) model to segment the plurality of users into a first plurality of groups based in part on a first set of features extracted from the user data, the first set of features associated with relative research-skill levels of the respective plurality of users;
using a second ML model to segment the plurality of users into a second plurality of groups based in part on a second set of features extracted from the user data, the second set of features associated with relative engagement levels of the respective plurality of users;
using a third ML model to classify the plurality of users into a plurality of classes based in part on the relative research-skill levels and the relative engagement levels of the respective plurality of users; and
selecting and presenting content to the plurality of users based in part on their respective classifications.

2. The computer-implemented method of claim 1, wherein the third ML model further takes a third set of features associated with the plurality of users in addition to the relative research-skill levels and the relative engagement levels of the respective plurality of users.

3. The computer-implemented method of claim 2, wherein the third set of features are extracted from survey data associated with the plurality of users.

4. The computer-implemented method of claim 2, wherein the third set of features are labeled instances associated with the plurality of users, each of the plurality of users being labeled as one of the plurality of classes.

5. The computer-implemented method of claim 1, wherein the first set of features or second set of features are pre-processed to reduce dimensionality of features.

6. The computer-implemented method of claim 1, wherein the first ML model or second ML model is trained using an unsupervised training method.

7. The computer-implemented method of claim 6, wherein the unsupervised training method includes a k-means clustering method.

8. The computer-implemented method of claim 1, wherein for each of the plurality of users, the first or second ML model computes a score for the user based on the first set of features or the second set of features, selects a set of cut-off scores, and segments the plurality of users into the first or second plurality of groups based on the set of cut-off scores.

9. The computer-implemented method of claim 8, wherein the plurality of users includes a first subset of users who are current subscribers of the genealogy service, a second subset of users who are current free trial users of the genealogy service, and a third subset of users who are churners, and the first or second ML model selects different sets of cut-off scores for the first, second, or third subsets of users.

10. The computer-implemented method of claim 8, wherein the plurality of users includes a first subset of current subscribers within a first tenure band, and a second subset of current subscribers within a second tenure band, and the first or second ML model selects different sets of cut-off scores for the first or second subsets of users.

11. The computer-implemented method of claim 1, wherein the third ML model is trained using a supervised training method.

12. The computer-implemented method of claim 1, wherein the plurality of classifications includes a core user classification and a casual or curious user classification.

13. The computer-implemented method of claim 1, wherein the first set of features or the second set of features include (1) a first subset of features associated with activities of the plurality of users during a first time frame, and (2) a second subset of features associated with activities of the plurality of users during a second time frame, and the first subset of features and the second subset of features are assigned different weights.

14. A non-transitory computer readable medium configured to store code comprising instructions, wherein the instructions, when executed by one or more processors, cause the one or more processors to:
access user data associated with a plurality of users of a genealogy service, user data comprising data associated with user interactions with the genealogy service;
use a first machine learning (ML) model to segment the plurality of users into a first plurality of groups based in part on a first set of features extracted from the user data, the first set of features associated with relative research-skill levels of the respective plurality of users;
use a second ML model to segment the plurality of users into a second plurality of groups based in part on a second set of features extracted from the user data, the second set of features associated with relative engagement levels of the respective plurality of users;
use a third ML model to classify the plurality of users into a plurality of classes based in part on the relative research-skill levels and the relative engagement levels of the respective plurality of users; and
select and present content to the plurality of users based in part on their respective classifications.

15. The non-transitory computer readable medium of claim 14, wherein the third ML model further takes a third set of features associated with the plurality of users in addition to the relative research-skill levels and the relative engagement levels of the respective plurality of users.

16. The non-transitory computer readable medium of claim 15, wherein the third set of features are extracted from survey data associated with the plurality of users.

17. The non-transitory computer readable medium of claim 15, wherein the third set of features are labeled instances associated with the plurality of users, each of the plurality of users being labeled as one of the plurality of classes.

18. The non-transitory computer readable medium of claim 14, wherein the first set of features or second set of features are pre-processed to reduce dimensionality of features.

19. The non-transitory computer readable medium of claim 14, wherein the first ML model or second ML model is trained using an unsupervised training method.

20. A computing system, comprising:
a processor; and
memory configured to store code comprising instructions, wherein the instructions, when executed by a processor, cause the processor to:
access user data associated with a plurality of users of a genealogy service, user data comprising data associated with user interactions with the genealogy service;
use a first machine learning (ML) model to segment the plurality of users into a first plurality of groups based in part on a first set of features extracted from the user data, the first set of features associated with relative research-skill levels of the respective plurality of users;
use a second ML model to segment the plurality of users into a second plurality of groups based in part on a second set of features extracted from the user data, the second set of features associated with relative engagement levels of the respective plurality of users;
use a third ML model to classify the plurality of users into a plurality of classes based in part on the relative research-skill levels and the relative engagement levels of the respective plurality of users; and
select and present content to the plurality of users based in part on their respective classifications.
